(19) United States
(12) Patent Application Publication
(10) Pub. No.: US 2018/0072096 A1
(43) Pub. Date: Mar. 15, 2018

(54) HUB ASSEMBLY ATTACHMENT UNIT, BICYCLE HUB ASSEMBLY, AND BICYCLE HUB ASSEMBLY STATE DETECTION SYSTEM

(71) Applicant: Shimano Inc., Osaka (JP)

(72) Inventors: Satoshi SHAHANA, Osaka (JP); Yuta MIZUTANI, Osaka (JP); Kanako KIYOKAWA, Osaka (JP)

(21) Appl. No.: 15/692,214

(22) Filed: Aug. 31, 2017

(30) Foreign Application Priority Data
Sep. 15, 2016 (JP) 2016-180969

(51) Int. Cl. B60B 27/00; G01P 3/487; G01L 3/10

(52) U.S. Cl. CPC B60B 27/0068; G01L 3/101; G01P 3/487

(57) ABSTRACT

A hub assembly attachment unit includes an attachment and a magnetism generator. The attachment is attachable to a thread at an end of a portion of a bicycle hub assembly that is rotatable relative to a hub axle in a direction extending along a rotational axis of the bicycle hub assembly. The thread is arranged coaxially with the rotational axis of the bicycle hub assembly. The magnetism generator is arranged integrally with the attachment.

### CROSS-REFERENCE TO RELATED APPLICATIONS

This application claims priority to Japanese Patent Application No. 2016-180969, filed on Sep. 15, 2016. The entire disclosure of Japanese Patent Application No. 2016-180969 is hereby incorporated herein by reference.

### BACKGROUND ART

### Field of the Invention

The present invention generally relates to a bicycle hub assembly attachment unit, a bicycle hub assembly and a bicycle hub assembly state detection system.

### Background Information

A technique for detecting a rotational state of a wheel is known in the art. For example, in Japanese Laid-Open Patent Publication No. 10-076988 (Patent Document 1), a magnet is attached to a spoke of a wheel, and a sensor detects the magnet to detect a wheel rotational state of a bicycle wheel.

### SUMMARY

It is an object of the present invention to provide a bicycle hub assembly attachment unit, a bicycle hub assembly and a bicycle hub assembly state detection system that detect a rotational state of a bicycle wheel or a rotational state of a rear sprocket.

In accordance with a first aspect of the invention, a hub assembly attachment unit includes an attachment and a magnetism generator. The attachment is attachable to a thread at an end of a portion of a bicycle hub assembly that is rotatable relative to a hub axle in a direction extending along the rotational axis of the bicycle hub assembly. The thread is arranged coaxially with the rotational axis of the bicycle hub assembly. The magnetism generator arranged integrally with the attachment. With the hub assembly attachment unit according to the first aspect, the magnetism generator is arranged integrally with the attachment. This allows the magnetism generator to be easily coupled to the bicycle hub assembly just by attaching the attachment to the thread of the bicycle hub assembly. The hub assembly attachment unit can be rotated relative to the hub axle in a state attached to the bicycle hub assembly. The attachment is attached to the thread that is coaxially arranged with the rotational axis of the bicycle hub assembly. This allows the hub assembly attachment unit to be attached to the bicycle hub assembly with limited influence on the rotational of the bicycle hub assembly.

In accordance with a second aspect of the invention, the hub assembly attachment unit according to the first aspect includes a tube. The tube includes an inner circumference and an outer circumference. One of the inner circumference and the outer circumference includes a thread. With the hub assembly attachment unit according to the second aspect, the hub assembly attachment unit can be attached to the bicycle hub assembly by attaching the tube of the attachment to the thread of the bicycle hub assembly.

In accordance with a third aspect of the invention, the hub assembly attachment unit according to the first or second aspect further includes a stopper configured to restrict movement of a rotational member attached to the bicycle hub assembly in the direction extending along the rotational axis of the bicycle hub assembly in a state in which the attachment is attached to the bicycle hub assembly. With the hub assembly attachment unit according to the third aspect, by attaching the hub assembly attachment unit to the bicycle hub assembly, the stopper restricts movement of the rotational member in the direction extending along the rotational axis of the bicycle hub assembly.

In accordance with a fourth aspect of the invention, the hub assembly attachment unit according to the second aspect further includes a stopper configured to restrict movement of a rotational member attached to the bicycle hub assembly in the direction extending along the rotational axis of the bicycle hub assembly in a state in which the attachment is attached to the bicycle hub assembly. The stopper projects outward in a radial direction from the outer circumference of the tube. With the hub assembly attachment unit according to the fourth aspect, by attaching the hub assembly attachment unit to the bicycle hub assembly, the stopper, which projects outward in the radial direction from the outer circumference of the tube, restricts movement of the rotational member in the direction extending along the rotational axis of the bicycle hub assembly.

In accordance with a fifth aspect of the invention, a hub assembly attachment unit includes an attachment and a magnetism generator. The attachment is attachable in a removable manner to a bicycle hub assembly including a hub axle. The attachment is configured to restrict movement of a rotational member attached to the bicycle hub assembly in a direction in which the hub axle extends in a state in which the attachment is attached to the bicycle hub assembly. The magnetism generator is arranged in a region located within an outer circumferential end of the attachment in a view taken from a direction parallel to the hub axle. With the hub assembly attachment unit according to the fifth aspect, the magnetism generator does not extend beyond the outer circumferential end of the attachment in a view taken from a direction parallel to the hub axle. This improves the outer appearance.

In accordance with a sixth aspect of the invention, the hub assembly attachment unit according to any one of the third to fifth aspects includes one of a disc brake rotor and a rear sprocket. With the hub assembly attachment unit according to the sixth aspect, movement of the disc brake rotor or the rear sprocket is restricted by attaching the hub assembly attachment unit to the bicycle hub assembly.

In accordance with a seventh aspect of the invention, the hub assembly attachment unit according to any one of the first to fifth aspects includes a magnetized portion obtained by magnetizing at least a portion of the attachment. With the hub assembly attachment unit according to the seventh aspect, the magnetized portion will not be separated from the attachment even when an impact is applied from the outside. Further, the hub assembly attachment unit is formed by fewer components.

In accordance with an eighth aspect of the invention, the hub assembly attachment unit according to the seventh aspect is located at a number of positions around an axis of the hub axle. With the hub assembly attachment unit according to the eighth aspect, magnetism changes occur in multiple cycles for each rotation of the wheel. This improves the resolution for detecting the magnetism of the magnetism generator with an external sensor.

In accordance with a ninth aspect of the invention, the hub assembly attachment unit according to any one of the first to fifth aspects is fixed to an outer surface of the attachment. With the hub assembly attachment unit according to the ninth aspect, strong magnetism can be emitted to the outside as compared to a case in which the magnetism generator exists inside the attachment.

In accordance with a tenth aspect of the invention, the hub assembly attachment unit according to any one of the first to fifth aspects further includes a receptacle that receives the magnetism generator. With the hub assembly attachment unit according to the tenth aspect, the attachment protects the magnetism generator.

In accordance with an eleventh aspect of the invention, the hub assembly attachment unit according to the tenth aspect is formed from a material that differs from that of a portion of the attachment excluding the receptacle. With the hub assembly attachment unit according to the eleventh aspect, the receptacle in the attachment is formed from a material that differs from that of a portion of the attachment excluding the receptacle. Thus, the material of the attachment can be selected from more materials.

In accordance with a twelfth aspect of the invention, the hub assembly attachment unit according to the eleventh aspect is located at an outer side of a portion of the attachment excluding the receptacle in the direction in which the hub axle extends in a state in which the attachment is attached to the bicycle hub assembly. With the hub assembly attachment unit according to the twelfth aspect, magnetism of the magnetism generator can easily be detected from the outer side of the attachment in the direction in which the hub axle extends.

In accordance with a thirteenth aspect of the invention, the hub assembly attachment unit according to any one of the tenth to twelfth aspects is press-fitted into, adhered to, or embedded in the receptacle. With the hub assembly attachment unit according to the thirteenth aspect the magnetism generator is press-fitted into, adhered to, or embedded in the receptacle. This limits separation of the magnetism generator from the receptacle.

In accordance with a fourteenth aspect of the invention, the hub assembly attachment unit according to the fifth aspect further includes an intermediate member held between the attachment and the rotational member in the direction in which the hub axle extends in a state in which the attachment is attached to the bicycle hub assembly. With the hub assembly attachment unit according to the fourteenth aspect, the magnetism generator can be formed separately from the attachment. Thus, the material of the attachment can be selected from more materials.

In accordance with a fifteenth aspect of the invention, the hub assembly attachment unit according to the fourteenth aspect includes a first through hole through which a portion of the bicycle hub assembly extends. With the hub assembly attachment unit according to the fifteenth aspect, the intermediate member is coupled to the bicycle hub assembly with the bicycle hub assembly extending through the intermediate member. This limits separation of the intermediate member from the bicycle hub assembly.

In accordance with a sixteenth aspect of the invention, the hub assembly attachment unit according to the fourteenth or fifteenth aspect includes a low permeability portion having a lower permeability than iron. With the hub assembly attachment unit according to the sixteenth aspect, the magnetism of the magnetism generator shielded by the attachment is limited. This allows an external sensor to easily detect the magnetism of the magnetism generator.

In accordance with a seventeenth aspect of the invention, the hub assembly attachment unit according to any one of the fourteenth to sixteenth aspects includes a second hole formed to expose an opposing portion of an outer surface of the intermediate member in a state in which the attachment is attached to the bicycle hub assembly. With the hub assembly attachment unit according to the seventeenth aspect, the magnetism of the magnetism generator is not shielded at the second through hole. This allows an external sensor to easily detect the magnetism of the magnetism generator.

In accordance with an eighteenth aspect of the invention, the hub assembly attachment unit according to any one of the preceding aspects includes a magnet. With the hub assembly attachment unit according to the eighteenth aspect, the magnetism generator includes a magnet. This allows the magnetism generator to be easily formed.

In accordance with a nineteenth aspect of the invention, the hub assembly attachment unit according to the eighteenth aspect is arranged at a number of locations around an axis of the hub axle. With the hub assembly attachment unit according to the nineteenth aspect, magnetism changes occur in multiple cycles for each rotation of the wheel. This improves the resolution for detecting the magnetism of the magnetism generator with an external sensor.

In accordance with a twentieth aspect of the invention, the hub assembly attachment unit according to the eighteenth aspect includes an annular multipolar magnet. With the hub assembly attachment unit according to the twentieth aspect, magnetism changes occur in multiple cycles for each rotation of the wheel. This improves the resolution for detecting the magnetism of the magnetism generator with an external sensor. The employment of the multipolar magnet facilitates the arrangement of the magnet as compared to a case in which multiple magnets are employed. This facilitates manufacturing.

In accordance with a twenty-first aspect of the invention, the hub assembly attachment unit according to any one of the preceding aspects includes an engagement portion that is engageable with a tool. With the hub assembly attachment unit according to the twenty-first aspect, a tool is allowed to be used to attach the attachment to the hub assembly. This reduces the burden on the user for attaching the attachment.

In accordance with a twenty-second aspect of the invention, a hub assembly attachment unit includes at attachment, an acceleration sensor and a transmitter. The attachment is attachable to an end of a portion of a bicycle hub assembly that is rotatable relative to a hub axle in a direction extending along a rotational axis of the bicycle hub assembly, which includes the hub axle. The acceleration sensor is supported by the attachment. The transmitter is supported by the attachment. The transmitter outputs information obtained from the acceleration sensor to outside the hub assembly attachment unit. With the hub assembly attachment unit according to the twenty-second aspect, by attaching the attachment to the bicycle hub assembly, the acceleration sensor can be attached to the bicycle hub assembly. Thus, the acceleration sensor is easily attached to the bicycle hub assembly. The hub assembly attachment unit is rotatable relative to the hub axle in a state attached to the bicycle hub assembly. The attachment can be attached to the end of a portion of a bicycle hub assembly that is rotatable relative to a hub axle in a direction extending along the rotational axis of the bicycle hub assembly. Thus, the attachment can easily be attached to the bicycle hub assembly.

In accordance with a twenty-third aspect of the invention, the hub assembly attachment unit according to the twenty-second aspect includes a through hole through which a portion of the bicycle hub assembly extends. With the hub assembly attachment unit according to the twenty-third aspect, the bicycle hub assembly is fitted into the through hole to attach the attachment. This limits separation of the attachment from the bicycle hub assembly.

In accordance with a twenty-fourth aspect of the invention, the hub assembly attachment unit according to the twenty-third aspect includes a first member that includes a through hole and a second member that is movable relative to the first member. The acceleration sensor is coupled to the second member. With the hub assembly attachment unit according to the twenty-fourth aspect, the acceleration sensor is movable relative to the first member. Further, after the first member is attached to the bicycle hub assembly, positioning of the acceleration sensor is facilitated.

In accordance with a twenty-fifth aspect of the invention, the hub assembly attachment unit according to the twenty-third aspect is attachable to a thread that is arranged coaxially with the rotation shaft at the end of bicycle hub assembly. With the hub assembly attachment unit according to the twenty-fifth aspect, the acceleration sensor can easily be coupled to the bicycle hub assembly just by attaching the attachment to the thread of the bicycle hub assembly.

In accordance with a twenty-sixth aspect of the invention, a bicycle hub assembly includes a hub shell and a magnetism generator arranged in a non-removable manner on an end of the hub shell in a direction extending along a rotational axis of the hub shell. With the hub assembly attachment unit according to the twenty-sixth aspect, separation of the magnetic generator from the hub shell is limited. The magnetism generator is arranged on the end of the hub shell in the direction extending along the rotational axis of the hub shell. This allows an external sensor to easily detect the magnetism of the magnetism generator.

In accordance with a twenty-seventh aspect of the invention, a bicycle hub assembly state detection system includes a detected portion and a sensor. The detected portion is arranged at an end of a portion of a bicycle hub assembly that is rotatable relative to a hub axle in a direction extending along a rotational axis of the bicycle hub assembly, which includes the hub axle. The sensor is arranged on a bicycle frame. The sensor detects the detected portion and outputs a signal corresponding to a rotational state of the bicycle hub assembly. The detected portion includes at least one of a permeability changing portion, at which permeability changes around the rotational axis of the bicycle hub assembly, an electromagnetic wave changing portion, at which reflectance of an electromagnetic wave changes around the rotational axis of the bicycle hub assembly, and a stepped portion, which includes a step around the rotational axis of the bicycle hub assembly. With the hub assembly attachment unit according to the twenty-seventh aspect, the detected portion is arranged at the end of the portion of the bicycle hub assembly that is rotatable relative to the hub axle in the direction extending along the rotational axis of the bicycle hub assembly. Thus, compared to when attaching the detected portion to an elongated component such as a wheel spoke, the coupling of the detected portion is performed more easily. In the bicycle hub assembly state detection system, the sensor detects at least one of a change in the permeability of the detected portion, the reflectance of electromagnetic waves at the detected portion, and the stepped portion of the detected portion. Thus, the bicycle hub assembly state detection system detects the rotational state of the hub assembly even if a detected body does not generate magnetism.

The hub assembly attachment system, the bicycle hub assembly, and the bicycle hub assembly detection system improve convenience.

### BRIEF DESCRIPTION OF THE DRAWINGS

Referring now to the attached drawings which form a part of this original disclosure.

FIG. 1 is a partial cross-sectional view of a hub assembly taken along a plane including a rotational axis in accordance with the illustrated embodiments.

FIG. 2 is a side elevational view of a hub assembly attachment unit in accordance with a first embodiment.

FIG. 3 is a partial cross-sectional view of the hub assembly in a state in which the hub assembly attachment unit of FIG. 2 is attached to the hub assembly.

FIG. 4 is an axial end elevational view of the hub assembly attachment unit of FIGS. 2 and 3.

FIG. 5 is a cross-sectional view of the hub assembly attachment unit taken along line 5-5 in FIG. 4.

FIG. 6 is an axial end elevational view of a modified hub assembly attachment unit of the first embodiment.

FIG. 7 is a cross-sectional view of the modified hub assembly attachment unit taken along line 7-7 in FIG. 6.

FIG. 8 is an axial end elevational view of another modified hub assembly attachment unit of the first embodiment.

FIG. 9 is a cross-sectional view of the modified hub assembly attachment unit taken along line 9-9 in FIG. 8.

FIG. 10 is a cross-sectional view of a hub assembly attachment unit in accordance with a second embodiment.

FIG. 11 is a plan view of the hub assembly attachment unit of FIG. 10.

FIG. 12 is a cross-sectional view of a hub assembly attachment unit in accordance with a third embodiment.

FIG. 13 is a cross-sectional view of a hub assembly attachment unit in accordance with a fourth embodiment.

FIG. 14 is an axial end elevational view of a hub assembly attachment unit in accordance with a fifth embodiment.

FIG. 15 is a cross-sectional view of the hub assembly attachment unit taken along line 15-15 in FIG. 14.

FIG. 16 is a partial cross-sectional view of the hub assembly in a state in which the hub assembly attachment unit of the fifth embodiment is attached to the hub assembly.

FIG. 17 is a partial cross-sectional view of the hub assembly in a state in which of the hub assembly attachment unit of the first embodiment and a disc brake rotor are attached to the hub assembly.

FIG. 18 is an exploded, cross-sectional view of a hub assembly attachment unit in accordance with a sixth embodiment of.

FIG. 19 is a partial cross-sectional view of a hub assembly including the hub assembly attachment unit of the sixth embodiment.

FIG. 20 is a cross-sectional view of a hub assembly attachment unit in accordance with a seventh embodiment.

FIG. 21 is a side view of a hub assembly in a state in which a hub assembly attachment unit in accordance with an eighth embodiment is attached to the hub assembly.

FIG. 22 is a block diagram showing an electrical configuration of the hub assembly attachment unit of FIG. 21.

FIG. 23 is a partial side view of a hub assembly in a state in which a hub assembly attachment unit in accordance with a ninth embodiment is attached to the hub assembly.

FIG. 24 is an exploded perspective view of a hub assembly attachment unit in accordance with a tenth embodiment.

FIG. 25 is an exploded perspective view of a hub assembly attachment unit in accordance with an eleventh embodiment.

FIG. 26 is a partially cross-sectional view of a hub assembly in a state in which a hub assembly attachment unit in accordance with a twelfth embodiment and a rear sprocket are attached to the hub assembly.

FIG. 27 is an axial end elevational view of the hub assembly attachment unit of FIG. 26.

FIG. 28 is a partially, cross-sectional view of a hub assembly in accordance with a thirteenth embodiment.

FIG. 29 is a schematic diagram a bicycle hub assembly state detection system in accordance with a fourteenth embodiment.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

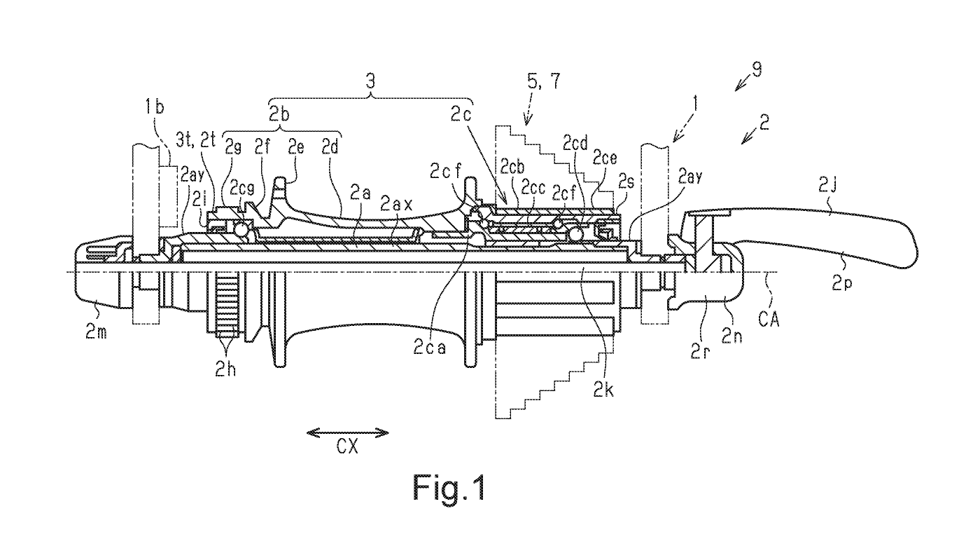

Referring initially to FIG. 1, a rear portion of a bicycle frame 1 supports a bicycle hub assembly 2 of a wheel 9. A hub assembly attachment unit 10 will now be described with reference to FIGS. 1 to 9. In the description hereafter, the hub assembly attachment unit 10 will simply be referred to as the attachment unit 10. The attachment unit 10 is a bicycle component used to detect a rotational state of the wheel 9 of a bicycle. The attachment unit 10 is coupled to the bicycle hub assembly 2 of the wheel 9 and rotated together with the wheel 9. The bicycle hub assembly 2 will hereafter simply be referred to as the hub assembly 2. The wheel 9 is supported by the bicycle frame 1. A magnetism detection sensor 1b is attached to the bicycle frame 1.

The attachment unit 10 is coupled in a removable manner to the hub assembly 2, which includes a hub axle 2a. The hub assembly 2 can be the so-called rear hub assembly that includes a freewheel 2c. Alternatively, the hub assembly 2 can be a front hub assembly that does not include the freewheel 2c. The attachment unit 10 can be coupled to either type of the hub assembly 2.

The hub assembly 2 shown in FIG. 1 is a rear hub assembly. The hub assembly 2 includes the hub axle 2a, a hub shell 2b and the freewheel 2c. Preferably, the hub assembly 2 further includes a wheel fastening member 2j. The two axial ends of the hub axle 2a are each coupled to the bicycle frame 1. The hub axle 2a includes a hub axle body 2ax and two nuts 2ay that are respectively coupled to the two axial ends of the hub axle body 2ax and insertable into support holes formed in the bicycle frame 1. The hub axle 2a does not necessarily include the nuts 2ay. The hub axle 2a can be hollow. The wheel fastening member 2j includes a shaft member 2k, which is inserted through the hub axle 2a. The wheel fastening member 2j further includes two coupling members 2m and 2n, which are respectively coupled to the two ends of the shaft member 2k. The coupling member 2m is fastened to a threaded portion formed on one end of the shaft member 2k. This allows the position of the shaft member 2k to be adjusted in the axial direction. The coupling member 2n includes a lever 2p and a movable portion 2r. Operation of the lever 2p allows the movable portion 2r to move relative to the shaft member 2k in the axial direction.

The bicycle frame 1 is held between the coupling members 2m and 2n to fix the hub axle 2a to the bicycle frame 1 in a removable manner. However, the structure of the hub axle 2a and the method for coupling the hub axle 2a to the bicycle frame 1 are not limited to the above description. For example, the coupling member 2m can be omitted, and a threaded portion on one end of the shaft member 2k can be coupled to a threaded portion of the bicycle frame 1. Further, for example, the two ends of the shaft member 2k can include threaded portions that are joined with nuts, and the bicycle frame 1 can be held between the nuts and portions of the shaft member 2k.

The freewheel 2c is configured to support one or more rear sprockets 5. The freewheel 2c includes a hub shell coupling portion 2ca, a sprocket supporting portion 2cb, a one-way clutch 2cc and a first bearing 2cd. The hub shell coupling portion 2ca is coupled to one axial end of the hub shell 2b and rotated integrally with the hub shell 2b. The sprocket supporting portion 2cb includes an outer circumference 2ce that supports the rear sprockets 5 in a removable manner. The sprocket supporting portion 2cb includes projections that engage with inner circumferences of the rear sprockets 5 to restrict rotation of the sprocket supporting portion 2cb relative to the rear sprockets 5 around a rotational axis CA. The rotational axis CA is defined by a center axis of the hub axle 2a. The outer circumference 2ce of the sprocket supporting portion 2cb can include an external thread that can be joined with an internal thread formed in inner circumferential surfaces of the rear sprockets 5. The sprocket supporting portion 2cb is arranged on the outer circumference of the hub shell coupling portion 2ca. The one-way clutch 2cc is located between the hub shell coupling portion 2ca and the sprocket supporting portion 2cb. In a case in which the sprocket supporting portion 2cb is rotated in a circumferential direction around the rotational axis CA, the sprocket supporting portion 2cb transmits rotational force to the hub shell coupling portion 2ca. The first bearing 2cd is located between the hub axle 2a and the hub shell coupling portion 2ca. Two bearings 2cf are arranged at opposite sides of the one-way clutch 2cc in the axial direction between the hub shell coupling portion 2ca and the sprocket supporting portion 2cb. The freewheel 2c is not limited to the structure described above. For example, the freewheel 2c can include a one-way clutch coupled to the hub shell 2b and the sprocket supporting portion 2cb and have a clutch plate that is movable along the rotational axis CA.

The hub shell 2b is rotatably coupled to the hub axle 2a. The hub shell 2b includes a tubular shell body 2d, two spoke connectors 2e and a tube 2f. The two spoke connectors 2e are respectively located at the two ends of the shell body 2d in a first direction CX that extends along the rotational axis CA of the hub axle 2a. The spoke connectors 2e each include a plurality of through holes to which the spokes of the wheel 9 are connected. The first direction CX includes the axial direction of the hub axle 2a. The tube 2f extends from the shell body 2d toward at an outer side of one of the spoke connectors 2e in the first direction CX. The shell body 2d, the spoke connectors 2e and the tube 2f form a one-piece structure.

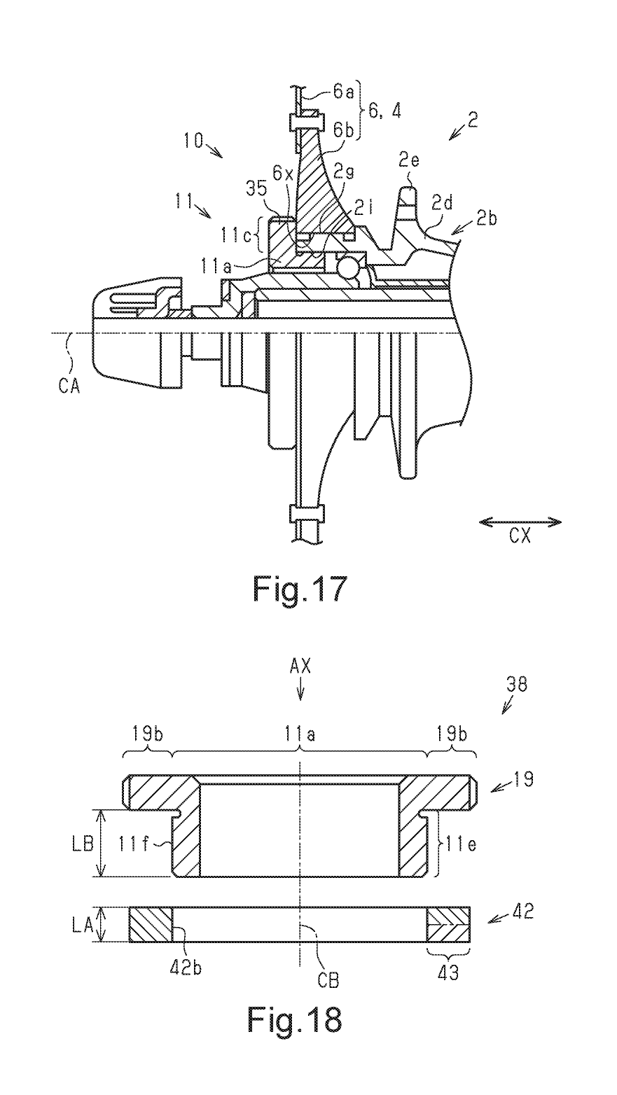

The tube 2f includes a rotor support 2g and a thread 2i. The rotor support 2g is defined by the outer circumference of the tube 2f. The rotor support 2g includes grooves 2h that extend in the first direction CX. The grooves 2h are arranged next to one another in the circumferential direction throughout the entire circumference of the rotor support 2g around the axis of the hub axle 2a. A disc brake rotor 6 shown in FIG. 17 can be coupled to the rotor support 2g. A through hole 6x extends through the central portion of the disc brake rotor 6 in the axial direction. An inner circumferential portion of the disc brake rotor 6 includes grooves that are engaged with the grooves 2h of the rotor support 2g. Preferably, the disc brake rotor 6 includes a rotor body 6a and a hub coupling member 6b that is located at the radially inner side of the rotor body 6a and joined with the rotor body 6a. The rotor body 6a and the hub coupling member 6b are coupled to each other by fastening bolts or by swaging pins. The through hole 6x is formed in the hub coupling member 6b. The hub coupling member 6b includes arms extending in the radial direction that are fixed to the rotor body 6a. The hub coupling member 6b is a center-lock adapter. The disc brake rotor 6 can be a one-piece structure.

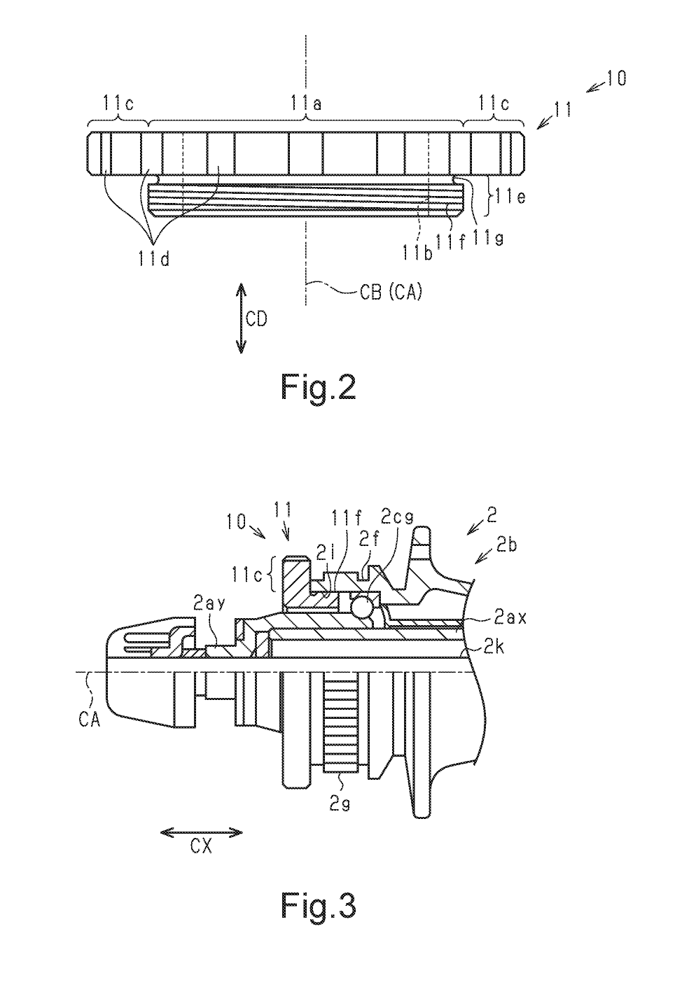

A second bearing 2cg is arranged between the inner circumference of the tube 2f and the hub axle 2a. A dust tube can be located between the second bearing 2cg and the hub shell coupling portion 2ca to enclose the hub axle 2a. The thread 2i is formed on the inner circumference of the tube 2f. The thread 2i is formed over a predetermined distance from the open end of the hub shell 2b in the first direction CX. The thread 2i spirally extends around the rotational axis CA of the hub assembly 2 in a direction extending along the rotational axis CA. The thread 2i is formed to engage a thread 11f of the attachment unit 10 (refer to FIG. 2).

The magnetism detection sensor 1b is coupled to the bicycle frame 1. The magnetism detection sensor 1b detects the magnetism of a magnetism generator 12 that rotates together with the hub shell 2b. For example, the magnetism detection sensor 1b is coupled to the bicycle frame 1. In a case in which the magnetism detection sensor 1b detects the magnetism of the magnetism generator 12 that is arranged on the rear hub assembly, the magnetism detection sensor 1b is coupled to a seat stay or a chain stay directly or by an interposing member. In a case in which the magnetism detection sensor 1b detects the magnetism of the magnetism generator 12 that is arranged on the front hub assembly, the magnetism detection sensor 1b is coupled to a front fork directly or by an interposing member. The magnetism detection sensor 1b is arranged on the bicycle frame 1 within a distance that allows for detection of the magnetism generator 12. The magnetism detection sensor 1b outputs a signal in accordance with changes in the magnetism to a bicycle component such as a bicycle controller (not shown) or a cycle computer. The magnetism detection sensor 1b detects the magnetism of the magnetism generator 12 to detect the rotational state of the wheel 9. The controller calculates, for example, the rotational speed of the wheel 9 based on the signal from the magnetism detection sensor 1b.

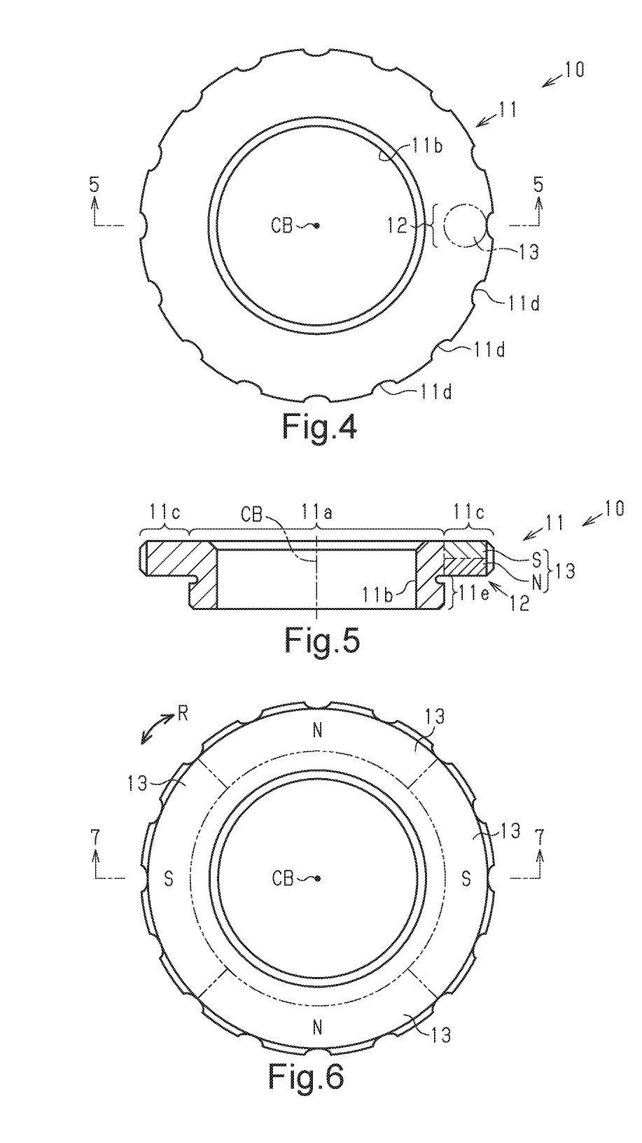

The attachment unit 10 will now be described with reference to FIGS. 2 to 5. The attachment unit 10 includes an attachment 11 and the magnetism generator 12 (refer to FIG. 4), which is arranged integrally with the attachment 11. The magnetism generator 12 generates magnetism.

In the direction extending along the rotational axis CA of the hub assembly 2, the attachment 11 is attachable to the thread 2i, which is arranged coaxially with the rotational axis CA, at an end 3t of a portion 3 of the hub assembly 2 that is rotatable relative to the hub axle 2a. The portion 3 of the hub assembly 2 that is rotatable relative to the hub axle 2a includes the hub shell 2b and the freewheel 2c. The end 3t of the portion 3 of the hub assembly 2 that is rotatable relative to the hub axle 2a includes an end 2t of the hub shell 2b and an end 2s of the freewheel 2c. The attachment 1 includes a tube 11a having a thread 11f formed in the outer circumference. The through hole 11b of the tube 11a is formed to have a size that allows for insertion of the hub axle 2a. The tube 11a extends continuously around the rotational axis CA. Preferably, the attachment 11 further includes a flange 11c. The flange 11c is located on the outer circumference of the tube 11a at one end in an axial direction CD of the tube 11a. The flange 11c projects outward in the radial direction from the tube 11a. The flange 11c is annular. Preferably, the flange 11c is ring-shaped. The flange 11c does not have to be annular. For example, the flange 11c can be formed by one or more projections extending in the radial direction from the tube 11a. The tube 11a and the flange 11c have a one-piece structure. The tube 11a and the flange 11c can be formed through casting, pressing, or machining. Preferably, the flange 11c has an outer diameter that is larger than that of the rotor support 2g. The thread 11f is formed in a first portion 11e of the outer circumference of the tube 11a where the flange 11c is not arranged. The thread 11f spirally extends from the end surface of the first portion 11e located at the opposite side of the flange 11c in a direction parallel to the axis CB of the tube 11a. Preferably, a groove 11g is formed between the thread 11f and the flange 11c extending in the circumferential direction around the axis CB of the tube 11a.

Preferably, the attachment 11 includes a first engagement portion 11d that is engaged with a tool. In the present embodiment, the flange 11c includes the first engagement portion 11d. Preferably, the first engagement portion 11d is arranged on, for example, the outer circumference of the flange 11c. The first engagement portion 11d includes a recess that is recessed in the radial direction of the flange 11c. Preferably, the first engagement portion 11d includes a plurality of recesses. Preferably, the recesses are evenly arranged in the circumferential direction around the axis CB of the tube 11a. To attach the attachment unit 10 to the hub shell 2b or remove the attachment unit 10 from the hub shell 2b, a tool is engaged with the first engagement portion 11d and rotated around the axis CA of the hub axle 2a. The first engagement portion 11d can include, for example, a projection that projects in a radial direction of the flange 11c. Preferably, the outermost circumferential surface of the first engagement portion 11d of the flange 11c with respect to the radial direction extends along a circle that is concentric with the flange 11c. Preferably, the first engagement portion 11d is formed so that it can be engaged with a dedicated tool and not with a versatile wrench. The axis of the flange 11c lies along the axis CB of the tube 11a.

The first portion 11e of the tube 11a is formed to be engageable with the inner side of the tube 2f of the hub shell 2b. In the description hereafter, the first portion 11e will be referred to as the second engagement portion 11e. The outer circumference of the second engagement portion 11e includes the thread 11f that is engageable with the thread 2i of the hub shell 2b.

As shown in FIG. 3, the attachment unit 10 is coupled to one end 2t of the hub shell 2b in the first direction CX. The thread 11f of the second engagement portion 11e in the attachment 11 is fastened to the thread 2i inside the tube 2f of the hub shell 2b. The fastening is performed until the flange 11c contacts one end surface of the hub shell 2b in the first direction CX to couple the attachment unit 10 to the hub shell 2b in a non-rotatable manner so that the attachment unit 10 is rotated integrally with the hub shell 2b.

The magnetism generator 12 is arranged in at least one of the tube 11a and the flange 11c. FIG. 5 shows an example in which the magnetism generator 12 is arranged in the flange 11c. The magnetism generator 12 includes a magnetized portion 13. The magnetized portion 13 is formed by magnetizing at least part of the attachment 11. The magnetized portion 13 includes the S-pole and the N-pole. There is no limit to the magnetizing method. At least the magnetism generator 12 in the attachment 11 can be formed from a material that is magnetized into a magnet (hereinafter referred to as “the magnet material”). The attachment 11 can have a layered structure in which layers of different materials are stacked in the axial direction of the attachment 11. The axial direction of the attachment 11 refers to the first direction CX that extends along the rotational axis CA of the hub assembly 2 in a state in which the attachment 11 is attached to the hub assembly 2. Examples of the magnet material include alnico, ferrite, and rare earths such as neodymium.

The attachment 11 includes one or more magnetism generators 12. For example, the magnetized portions 13 are located at a number of positions around the axis CA of the hub axle 2a. The axis CA of the hub axle 2a is the rotational axis CA of the bicycle hub assembly 2. Regardless of whether there is only one magnetized portion 13 or more magnetized portions 13, there is no limitation to the direction in which the S-pole and the N-pole are arranged in each magnetized portion 13. For example, the S-pole and the N-pole can be arranged in the axial direction of the attachment 11, the radial direction, or in the circumferential direction R around the axis CB of the tube 11a.

FIGS. 4 and 5 show an example of the attachment unit 10 that includes only one magnetism generator 12. In this example, the S-pole and the N-pole are arranged on the axial direction of the attachment 11.

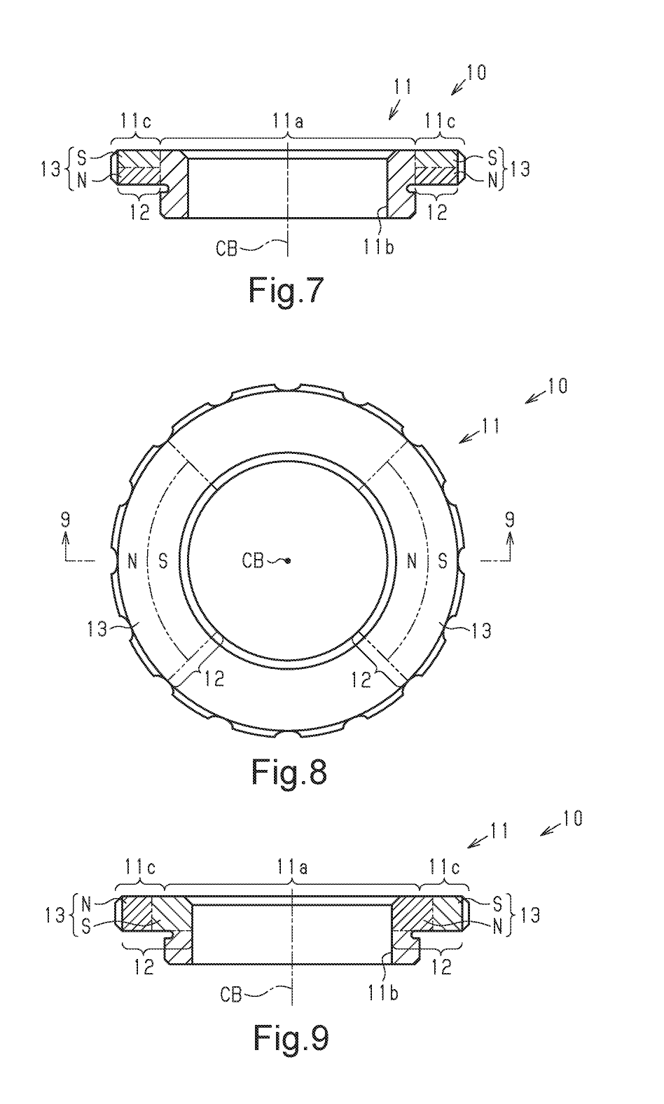

FIGS. 6 and 7 show an example of the attachment unit 10 that includes four magnetism generators 12. In this example, the S-poles and the N-poles of the magnetism generators 12 are alternately arranged in the circumferential direction R. The magnetism generators 12 are arranged adjacent to one another in the circumferential direction R. Each of the magnetism generators 12 occupies one-fourth of the flange 11c in the circumferential direction R. In FIGS. 6 and 7, the magnetism generators 12 are continuously arranged in the circumferential direction R but can be spaced apart from one another in the circumferential direction R.

FIGS. 8 and 9 show an example of the attachment unit 10 that includes two magnetism generators 12. In this example, the S-pole and the N-pole of each magnetism generator 12 is arranged in the radial direction. The magnetism generators 12 are spaced apart from each other in the circumferential direction R. Each of the magnetism generators 12 occupies one-fourth of the flange 11c in the circumferential direction R around the axis CB of the tube 11a. In FIGS. 8 and 9, the magnetism generators 12 are spaced apart from each other in the circumferential direction R but can be arranged adjacent to each other in the circumferential direction R.

In configurations including a plurality of the magnetism generators 12 such as those shown in FIGS. 6 to 9, an increase in the number of the magnetism generators 12 improves the resolution of the magnetism detection sensor 1b that detects the magnetism of the magnetism generators 12. For example, the number of the magnetism generators 12 can be large such as 32, 64, or 128. Preferably, in a case in which there is a plurality of the magnetism generators 12, the magnetism generators 12 are in rotational-symmetry around the axis CB of the tube 11a, the distance is equal between adjacent magnetism generators 12, and each of the magnetism generators 12 has an equal size in the circumferential direction R. The rotational speed of the wheel 9 is calculated in the following manner. As the rotation of the wheel 9 rotates the hub shell 2b, the attachment 11 rotates together with the hub shell 2b. During the rotation, the magnetism generator 12 passes by the proximity of the magnetism detection sensor 1b. If the magnetism detection sensor 1b detects magnetism, the magnetism detection sensor 1b outputs a signal corresponding to the polarity. If there is a plurality of the magnetism generators 12, then the polarity of the magnetism detected by the magnetism detection sensor 1b is reversed whenever the magnetism generator 12 passes by the proximity of the magnetism detection sensor 1b. The magnetism detection sensor 1b outputs a signal corresponding to the polarity. The controller calculates a magnetism detection cycle from the signals output by the magnetism detection sensor 1b or calculates the polarity reversing cycle to obtain the rotational speed of the wheel 9.

### Second Embodiment

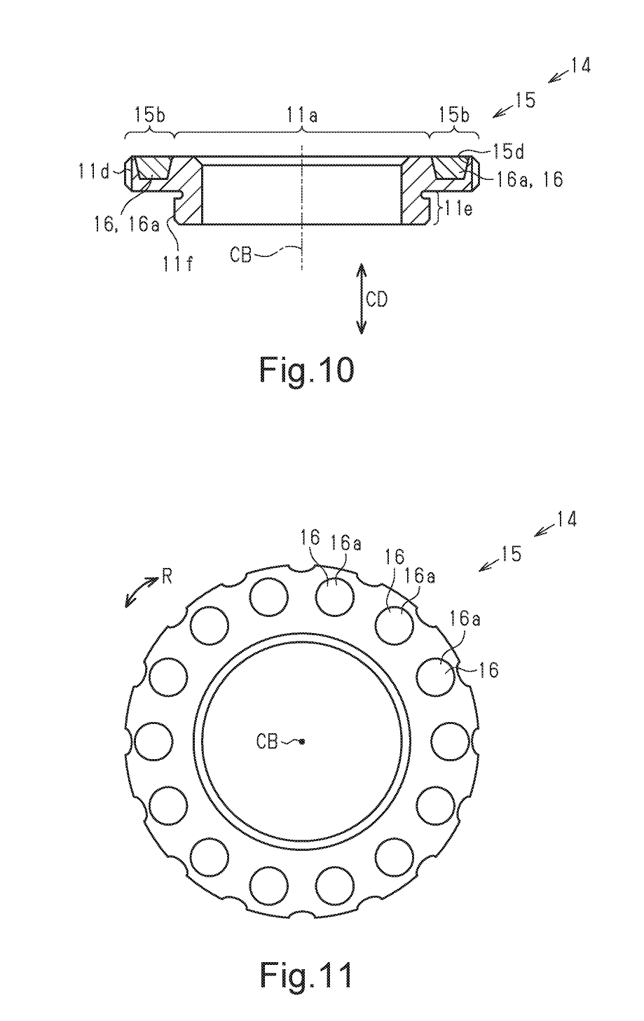

A second embodiment of an attachment unit 14 will now be described with reference to FIGS. 10 and 11. The attachment unit 14 differs from the attachment unit 10 of the first embodiment only in the magnetism generator and part of the attachment. In the description hereafter, same reference numerals are given to those components that are the same as the corresponding components of the first embodiment. Such components will not be described in detail.

The attachment unit 14 includes an attachment 15 and a magnetism generator 16, which is arranged integrally with the attachment 15. In the direction extending along the rotational axis CA of the hub assembly 2, the attachment 15 is attachable to the thread 2i, which is arranged coaxially with the rotational axis CA, at the end 3t of the portion 3 of the hub assembly 2 that is rotatable relative to the hub axle 2a. The magnetism generator 16 is formed as a member that is separate from the attachment 15. The magnetism generator 16 is coupled to the attachment 15 in a non-rotatable manner relative to the attachment 15. The attachment 15 includes a receptacle 15d that receives the magnetism generator 16. The attachment unit 14 can include one or more magnetism generators 16. FIGS. 10 and 11 show a case in which the attachment unit 14 includes a plurality of the magnetism generators 16. In a state in which the attachment 15 is attached to the hub assembly 2, the receptacle 15d is located at an outer side of the portion of the attachment 15 excluding the receptacle 15d in the direction in which the hub axle 2a extends.

The attachment 15 includes the tube 11a and a flange 15b. The flange 15b is located on the outer circumference of the tube 11a at one end in the axial direction CD of the tube 11a. The flange 15b projects outward in a radial direction of the tube 11a. The flange 15b is annular. Preferably, the flange 15b is ring-shaped. The flange 15b does not have to be annular. For example, the flange 15b can be formed by one or more projections extending in the radial direction from the tube 11a. The tube 11a and the flange 15b have a one-piece structure. Preferably, the outer circumference of the flange 15b includes the first engagement portion 11d.

The receptacle 15d is included in the flange 15b. The second engagement portion 11e of the tube 11a is a portion of the tube 11a where the flange 15b is not arranged. The tube 11a and the flange 15b are formed through casting, pressing, or machining. The flange 15b accommodates at least a portion of the magnetism generator 16. At least a portion of the magnetism generator 16 is accommodated in the receptacle 15d. Preferably, the magnetism generator 16 is arranged in the receptacle 15d so as not to project from the receptacle 15d. The receptacle 15d includes at least one of a recess, a through hole, or a hollow. If the receptacle 15d includes a recess, the recess preferably opens in the end surface of the flange 15b in the axial direction CD of the tube 11a.

FIG. 10 shows a case in which the receptacle 15d includes a recess. Among the two end surfaces of the flange 15b in the axial direction CD of the tube 11a, the opening of the recess is located in the end surface that is farther from the thread 11f. In this case, in a state in which the attachment unit 14 is coupled to the hub assembly 2, the magnetism generator 16 can be arranged at a position that is close to the bicycle frame 1. Among the two end surfaces of the flange 15b in the axial direction CD of the tube 11a, the opening of the recess can be located in the end surface that is closer to the thread 11f. In a case in which the receptacle 15d includes a through hole, the through hole extends in the axial direction CD of the tube 11a.

In a case in which the attachment unit 14 includes a plurality of the magnetism generators 16, as shown in FIG. 11, the magnetism generators 16 are preferably arranged in the attachment 15 at equal intervals in the circumferential direction around the axis CB of the tube 11a. Preferably, the magnetism generators 16 have the same size and generate magnetism having the same strength. In a case in which the attachment unit 14 includes a plurality of the magnetism generators 16, preferably, a plurality of receptacles 15d are arranged around the axis CB of the tube 11a. The receptacles 15d are spaced apart from one another around the axis CB of the tube 11a. In a case in which there is a plurality of the receptacles 15d, preferably, the receptacles 15d are in rotational-symmetry around the axis CB of the tube 11a, and the distance is equal between adjacent receptacles 15d.

The magnetism generator 16 is press-fitted into, adhered to, or embedded in the receptacle 15d. For example, if the receptacle 15d includes a recess or a through hole, then the magnetism generator 16 is press-fitted into the receptacle 15d. If the receptacle 15d includes a recess or a through hole, then the magnetism generator 16 can be received in the receptacle 15d and fixed by an adhesive to the attachment 15. In a case in which the receptacle 15d includes a recess, a through hole, or a hollow, the magnetism generator 16 can be insert-molded in the receptacle 15d. By insert-molding and embedding the magnetism generator 16 in the receptacle 15d, the magnetism generator 16 can be arranged in the flange 15b so that the magnetism generator 16 is completely concealed. In a state in which the magnetism generator 16 is received in the receptacle 15d, the magnetism generator 16 can be fixed to the receptacle 15d with an interposing member filling the gap between the magnetism generator 16 and the receptacle 15d.

The magnetism generator 16 includes a magnet 16a. Preferably, the magnet 16a is a permanent magnet. The magnet 16a can be an electromagnet. In this case, the electromagnet needs to be supplied with power by arranging a power supply such as a battery or a hub dynamo in the hub assembly. For example, the magnetism generator 16 can be formed by a magnet or a member including a magnet. In the latter case, for example, the magnetism generator 16 is formed by a magnet and a resin member that covers the magnet. The attachment unit 14 includes a plurality of the magnetism generators 16. In the attachment unit 14, a plurality of the magnets 16a are arranged at a number of positions around the axis of the hub axle 2a. Regardless of whether there is only one magnet 16a or a number of magnets 16a, there is no limitation to the direction in which the S-pole and the N-pole is arranged in each magnet 16a. For example, the S-pole and the N-pole can be arranged in the axial direction CD of the tube 11a, the radial direction, or the circumferential direction R around the axis CB of the tube 11a. For example, in a case in which the S-pole and the N-pole of each of the magnets 16a is arranged in the axial direction CD of the tube 11a, preferably, the magnets 16a that are adjacent to each other around the axis CB of the tube 11a are arranged so that the S-pole and N-pole of one magnet 16a are located at sides opposite to the S-pole and N-pole of the other magnet 16a. The magnetism generator 16 can include an annular multipolar magnet. For example, an annular multipolar magnet has a structure in which the S-poles and N-poles are alternately arranged in the circumferential direction around the axis CB of the tube 11a. In a case in which a multipolar magnet is used, the receptacle 15d includes a recess or a hollow. Further, the annular multipolar magnet is at least partially received in the recess. Alternatively, the annular multipolar magnet is completely received in the hollow. Preferably, the annular multipolar magnet is received in the recess. The annular multipolar magnet is, preferably, ring-shaped.

In a case in which the magnetism generator 16 is arranged in a recess or a through hole and at least a portion of the magnetism generator 16 is exposed to the outside, the attachment 15 can be formed from a metal, such as an iron alloy or an aluminum alloy, or a synthetic resin. In a case in which the magnetism generator 16 is embedded in the attachment 15, the attachment 15 can be formed from a synthetic resin or a metal such as aluminum alloy so that magnetism is transmitted to the outside through the attachment 15. In the present embodiment, the magnet 16a is arranged in only the flange 15b. However, the magnet 16a can be arranged in only the tube 11a or in both of the flange 15b and the tube 11a. In a case in which the magnet 16a is arranged in the tube 11a, the tube 11a includes a receptacle that receives at least a portion of the magnet 16a.

### Third Embodiment

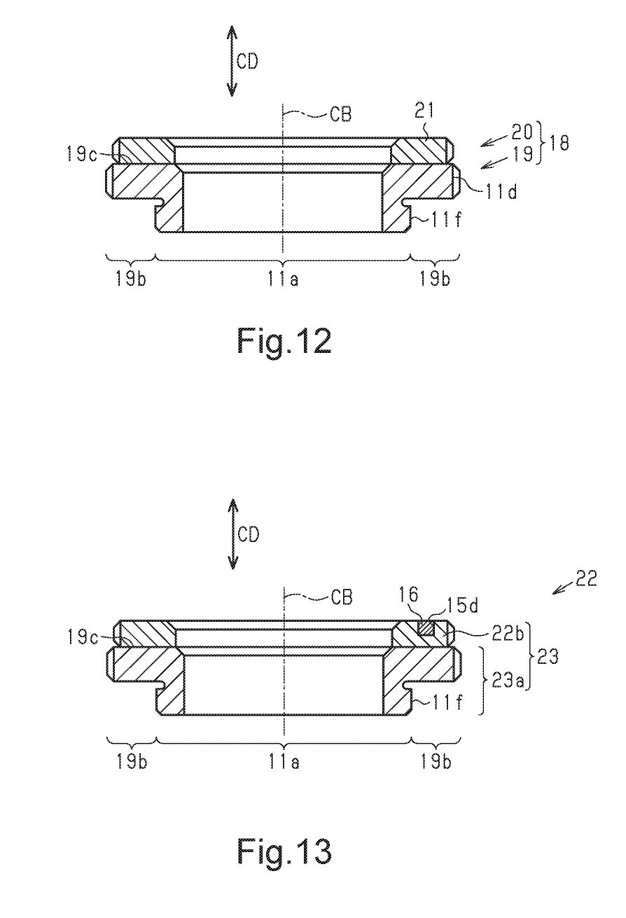

A third embodiment of an attachment unit 18 will now be described with reference to FIG. 12. The third embodiment of the attachment unit 18 differs from the attachment units 10 and 14 of the first and second embodiments only in the magnetism generator and part of the attachment. In the description hereafter, same reference numerals are given to those components that are the same as the corresponding components of the first and second embodiments. Such components will not be described in detail.

The attachment unit 18 includes an attachment 19 and a magnetism generator 20, which is arranged integrally with the attachment 19. In the direction extending along the rotational axis CA of the hub assembly 2, the attachment 19 is attachable to the end 3t of the portion 3 of the hub assembly 2 that is rotatable relative to the hub axle 2a at the thread 2i, which is arranged coaxially with the rotational axis CA. In the same manner as the second embodiment, the magnetism generator 20 is formed by a member that is separate from the attachment 19. The third embodiment differs from the second embodiment in that the attachment 19 does not include a structure for receiving the magnetism generator 20.

The attachment 19 includes the tube 11a and a flange 19b. The flange 19b is located on the outer circumference of the tube 11a at one end in the axial direction CD of the tube 11a. The flange 19b projects outward in the radial direction from the tube 11a. The flange 19b is annular. Preferably, the flange 19b is ring-shaped. The flange 19b does not have to be annular. For example, the flange 19b can be formed by one or more projections extending in the radial direction from the tube 11a. The tube 11a and the flange 19b have a one-piece structure. Preferably, the first engagement portion 11d is defined by the outer circumference of the flange 19b. The flange 19b includes one or more magnetism generators 20. The magnetism generator 20 is fixed to an outer surface 19c of the attachment 19. Preferably, in the outer surface 19c of the flange 19b, the magnetism generator 20 is fixed to the end surface of the axial direction CD of the tube 11a. In FIG. 12, among the two end surfaces of the flange 19b in the axial direction CD of the tube 11a, the magnetism generator 20 is fixed to the end surface that is farther from the thread 11f. The magnetism generator 20 is fixed by an adhesive to the attachment 19 and integrated with the attachment 19. If the attachment 19 and the magnetism generator 20 are both formed from metal, then the magnetism generator 20 can be fixed to the attachment 19 through brazing or welding. The magnetism generator 20 can be fixed by bolts (not shown) to the attachment 19. The attachment 19 and the magnetism generator 20 can be formed from different materials.

The flange 19b does not have to be annular. For example, the flange 19b can be formed from one or more projections that extend from the tube 11a in the radial direction.

The magnetism generator 20 is, for example, annular. The magnetism generator 20 is preferably ring-shaped. The inner diameter of the magnetism generator 20 is larger than the outer diameter of the hub axle 2a. Preferably, the inner diameter of the magnetism generator 20 is larger than the inner diameter of the tube 11a. The magnetism generator 20 can include one or more magnetized portions like in the first embodiment and can include an annular multipolar magnet like in the second embodiment. In a case in which the magnetism generator 20 includes one or more magnetized portions, an annular member 2l that is similar to the flange 11c of the first embodiment includes the one or more magnetized portions. The one or more magnetized portions are formed in the annular member 2l in the same manner as the magnetization of the flange 11c in the first embodiment. In a case in which the magnetism generator 20 includes an annular multipolar magnet, the multipolar magnet is directly fixed to the flange 19b. The magnetism generator 20 does not have to be annular and can be arranged at one location around the axis CB of the tube 11a or at a number of locations spaced apart from one another in the circumferential direction. In this case, the magnetism generator 20 preferably includes a magnet. In a case in which there is a plurality of the magnetism generators 20, magnets are arranged at equal intervals around the axis CB of the tube 11a.

In a view of the attachment unit 18 taken in a direction parallel to the axis of the hub axle 2a, the magnetism generator 20 is preferably arranged in a region located within the outer circumferential end of the attachment 19. For example, if the magnetism generator 20 has a circular contour in a view taken in a direction parallel to the axis of the hub axle 2a, then the diameter of the magnetism generator 20 is smaller than the diameter of the flange 19b of the attachment 19. Preferably, the magnetism generator 20 is arranged coaxially with the rotational axis CA of the hub assembly 2. In such a case, in a view of the attachment unit 18 attached to the hub shell 2b taken in a direction parallel to the axis of the hub axle 2a, the outer edge of the magnetism generator 20 does not extend beyond the outer edge of the attachment 19. Thus, the attachment unit 18 has an integral outer appearance. Further, if a tool is engaged with the first engagement portion 11d, the magnetism generator 20 does not interfere with the tool. In a case in which the magnetism generator 20 is annular, the inner circumference can include a thread that is engageable with the thread 11f of the tube 11a so that the magnetism generator 20 is fastened to the tube 11a and fixed to the second engagement portion 11e.

### Fourth Embodiment

A fourth embodiment of an attachment unit 22 will now be described with reference to FIG. 13. The attachment unit 22 differs from the attachment units 14 and 18 of the second and third embodiments only in the magnetism generator and part of the attachment. In the description hereafter, same reference numerals are given to those components that are the same as the corresponding components of the second and third embodiments. Such components will not be described in detail.

The attachment unit 22 includes an attachment 23 and the magnetism generator 16, which is arranged integrally with the attachment 23. The attachment unit 22 differs from the attachment unit 14 of the second embodiment in that the material of a receptacle 22b that receives the magnetism generator 16 in the attachment 23 differs from the material forming portions other than the receptacle 22b. The receptacle 22b includes a surface that supports the magnetism generator 16 and portions surrounding that surface.

The attachment 23 includes the receptacle 22b that receives the magnetism generator 16. The receptacle 22b is integrally formed with an attachment body 23a. The attachment body 23a has the same structure as the attachment 19 of the third embodiment. The receptacle 22b is an annular member similar to the flange 15b of the second embodiment. The receptacle 22b includes at least one of a recess, a through hole, or a hollow in the same manner as the receptacle 15d of the second embodiment. Preferably, the receptacle 22b is fixed to the outer surface 19c of the flange 19b of the attachment body 23a at the end surface in the axial direction CD of the tube 11a. In FIG. 13, among the two end surfaces of the flange 19b in the axial direction CD of the tube 11a, the receptacle 22b is fixed to the end surface that is farther from the thread 11f. The inner diameter of the receptacle 22b is larger than the outer diameter of the hub axle 2a. Preferably, the inner diameter of the receptacle 22b is larger than the inner diameter of the tube 11a. In a view of the attachment unit 22 taken from a direction parallel to the axis of the hub axle 2a, preferably, the receptacle 22b is arranged in a region located within the outer circumferential end of the attachment body 23a. The attachment body 23a and the receptacle 22b are separate members and formed separately. The receptacle 22b is formed from a material that differs from the material forming portions of the attachment 23 other than the receptacle 22b. The attachment body 23a is formed from a material having high rigidity such as an iron alloy and an aluminum alloy. The receptacle 22b is formed by a material that allows the receptacle 22b to hold the magnetism generator 16. For example, the receptacle 22b is formed from a resin or a metal such as an iron alloy and an aluminum alloy. In a case in which the magnetism generator 16 is embedded in the receptacle 22b, the receptacle 22b can be formed from a synthetic resin or a metal such as an aluminum alloy that allows magnetism to be transmitted to the outer side of the receptacle 22b. The attachment body 23a and the receptacle 22b can be fixed to each other by bolts (not shown) or an adhesive. In a case in which the attachment body 23a and the receptacle 22b are both formed from metal, the receptacle 22b can be fixed to the attachment body 23a through brazing or welding.

The magnetism generator 16 is fixed to the receptacle 22b in the same manner as the magnetism generator 16 that is fixed to the receptacle 15d in the second embodiment. Thus, such a process will not be described here. If the receptacle 22b is annular, the inner circumference can include a thread that is engageable with the thread 11f of the tube 11a to fasten and fix the receptacle 22b to the tube 11a. The receptacle 22b does not have to be annular and can be arranged at one location around the axis CB of the tube 11a or at a number of locations spaced apart in the circumferential direction.

### Fifth Embodiment

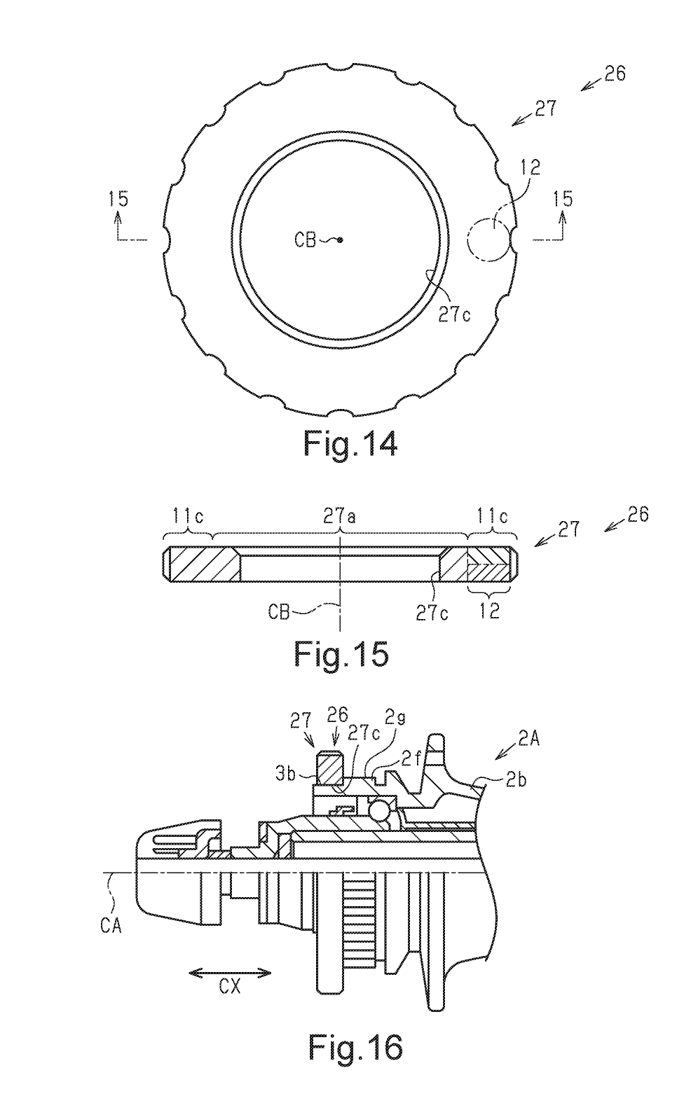

A fifth embodiment of an attachment unit 26 will now be described with reference to FIGS. 14 to 16. The attachment unit 26 of the present embodiment differs from the attachment unit 10 of the first embodiment only in the attachment. In the description hereafter, same reference numerals are given to those components that are the same as the corresponding components of the first embodiment. Such components will not be described in detail. In the first embodiment, the thread 11f is located on the outer circumference of the attachment 11 of the tube 11a. In the attachment unit 26, a thread 27c is formed in an inner circumference of the tube 27a of the attachment 27. The attachment unit 26 is attachable to the hub shell 2b that includes an external thread.

A hub assembly 2A, to which the attachment unit 26 is attachable, differs from the hub assembly 2 only in the structure of the tube in the hub shell. The tube 2f of the hub assembly 2A includes the rotor support 2g and a thread 3b. The thread 3b is located on the outer circumference of the tube 2f. The thread 3b spirally extends around the rotational axis CA of the hub assembly 2A in a direction parallel to the rotational axis CA. The thread 3b is formed to engage the thread 27c of the attachment unit 26 (refer to FIG. 15). The thread 3b is formed over a predetermined distance from the open end of the hub shell 2b in the first direction CX and can extend to the rotor support 2g.

The attachment unit 26 includes the attachment 27 and the magnetism generator 12. The attachment 27 includes the tube 27a and the flange 11c. The inner circumference of the tube 27a includes the thread 27c that engages the thread 3b formed on the outer circumference of the tube 2f of the hub shell 2b. The flange 11c is arranged on the outer circumference of the tube 27a. In the present embodiment, the dimensions of the tube 27a and the flange 11c are equal in the direction extending along the axis CB of the tube 27a. However, the dimensions can be different. The tube 27a and the flange 11c have a one-piece structure. The tube 27a and the flange 11c are formed through casting, pressing, or machining. In the same manner as the first embodiment, the magnetism generator 12 is arranged integrally with the flange 11c. Basically, the attachment unit 26 has the same structure as the attachment 11 of the attachment unit 10 in the first embodiment, except that the thread 27c is formed on the inner circumference instead of the thread 11f formed on the outer circumference.

Instead of the flange 11c and the magnetism generator 12, the attachment 27 can include the flange 15b and the magnetism generator 16 of the second embodiment. Basically, such a structure is the same as the attachment 15 of the attachment unit 14, except that the attachment 27 includes the thread 27c formed on the inner circumference instead of the thread 11f formed on the outer circumference. Instead of the flange 11c and the magnetism generator 12, the attachment 27 can include the flange 19b and the magnetism generator 20 of the third embodiment. Basically, such a structure is the same as the attachment 19 of the attachment unit 18 in the third embodiment, except that the attachment 27 includes the thread 27c formed on the inner circumference instead of the thread 11f formed on the outer circumference. The attachment 27 can include the flange 19b, the receptacle 22b, and the magnetism generator 16 of the fourth embodiment instead of the flange 11c and the magnetism generator 12. Basically, such a structure is the same as the attachment 23 of the attachment unit 22 in the fourth embodiment, except that the attachment 27 includes the thread 27c formed on the inner circumference instead of the thread 11f formed on the outer circumference.

FIG. 17 shows an example in which a rotational member 4 is coupled and fixed to the hub assembly 2 with the attachment unit 10. The rotational member 4 includes the disc brake rotor 6 and the rear sprockets 5 (refer to rear sprocket assembly 7 of FIG. 26). The disc brake rotor 6 will hereafter be referred to as the rotor 6. FIG. 17 shows an example in which the rotor 6 is coupled and fixed to the hub assembly 2 with the attachment unit 10. In a state in which the attachment 11 is attached to the hub assembly 2, a stopper 35 restricts movement of the rotational member 4, which is attached to the hub assembly 2, in the first direction CX extending along the rotational axis CA of the hub assembly 2. The stopper 35 projects outward in the radial direction from the outer circumference of the tube 11a. In the attachment unit 10, the flange 11c functions as the stopper 35. The outer diameter of the flange 11c is larger than the outer diameter of the rotor support 2g.

As shown in FIG. 17, in a state in which the rotor 6 is attached to the rotor support 2g of the hub shell 2b, the attachment 11 is coupled to the hub assembly 2. The flange 11c contacts the hub coupling member 6b of the rotor 6, and the rotor 6 is pushed toward the shell body 2d. The hub coupling member 6b is held between the flange 11c and a portion of the tube 2f in the first direction CX. This restricts movement of the hub coupling member 6b in the first direction CX. FIG. 17 shows an example in which the rotor 6 is fixed to the hub shell 2b with the attachment unit 10. The attachment units 14, 18, 22 and 26 of the second to fifth embodiments can also be used to fix the rotor 6 to the hub shell 2b. In this case, the outer diameter of each of the flanges 15b, 19b, 19b and 11c is larger than the outer diameter of the rotor support 2g. In the attachment unit 14 of the second embodiment, the flange 15b functions as the stopper 35. In the attachment unit 18 of the third embodiment, the flange 19b functions as the stopper 35. In the attachment unit 22 of the fourth embodiment, the flange 19b functions as the stopper 35. In the attachment unit 26 of the fifth embodiment, the flange 11c functions as the stopper 35.

### Sixth Embodiment

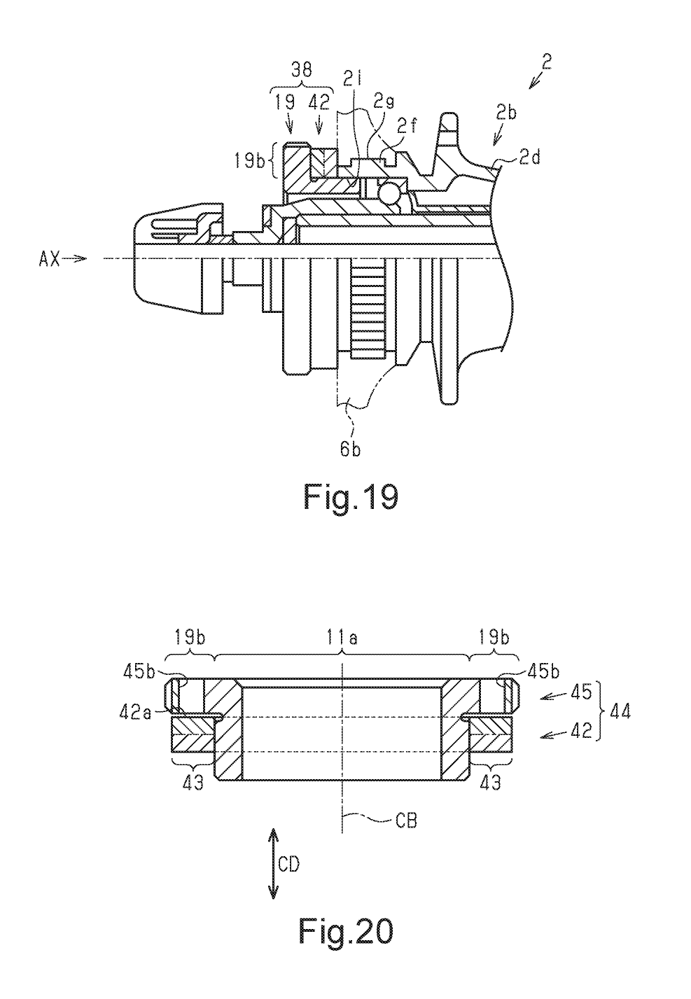

A sixth embodiment of an attachment unit 38 will now be described with reference to FIGS. 18 and 19. In the description hereafter, same reference numerals are given to those components that are the same as the corresponding components of the attachment units 10, 14, 18, 22, and 26 in the first to fifth embodiments. Such components will not be described in detail. The attachment unit 38 includes the attachment 19, a magnetism generator 43, and an intermediate member 42. The magnetism generator 43 is formed by a member that is separate from the attachment 19. In the third embodiment, the magnetism generator 20 is arranged integrally with the attachment 19. However, in the attachment unit 38, the attachment 19 and the magnetism generator 43 are not integrated with each other and are separately coupled to the hub assembly 2. The attachment 19 is coupled in a removable manner to the hub assembly 2, which includes the hub axle 2a. In a state attached to the hub assembly 2, the attachment 19 restricts movement of the rotational member 4 in the direction in which the hub axle 2a extends. In a view taken from a direction parallel to the hub axle 2a, the magnetism generator 43 is arranged in a region located within the outer circumferential end of the attachment 19.

The attachment unit 38 further includes the intermediate member 42. In a state in which the attachment 19 is attached to the hub assembly 2, the intermediate member 42 is held between the attachment 19 and the rotational member 4 in the direction in which the hub axle 2a extends. The magnetism generator 43 is arranged on the intermediate member 42.

The intermediate member 42 and the attachment 19 are separate members. The intermediate member 42 can function as the magnetism generator 43. A portion of the intermediate member 42 can function as the magnetism generator 43. The intermediate member 42 is not coupled to the attachment 19 in a non-movable manner. However, the attachment 19 and the intermediate member 42 are coupled to the hub assembly 2 so that the attachment 19 and the magnetism generator 43 integrally rotate with the hub assembly 2.

In a state in which the rotational member 4 is not attached, the attachment 19 is coupled to the hub assembly 2. The flange 19b pushes the intermediate member 42 toward the shell body 2d so that the intermediate member 42 is held between the flange 19b and the hub shell 2b. The intermediate member 42 held between the flange 19b and the hub shell 2b restricts rotation of the hub shell 2b around the rotational axis CA.

The attachment 19 can be formed from an iron alloy. Preferably, the attachment 19 includes a low permeability portion having a lower permeability than iron. At least a portion of the attachment 19 can be formed from a material having a lower permeability than iron. Alternatively, the attachment 19 can entirely be formed from a material having a lower permeability than iron. Materials having a lower permeability than iron include aluminum alloys and resins. In particular, it is preferred that at least a portion of the flange 19b include a material having a lower permeability than iron.

The intermediate member 42 includes a first through hole 42b through which a portion of the hub assembly 2 can extend. For example, the intermediate member 42 is annular. Preferably, the intermediate member 42 is ring-shaped. The first through hole 42b of the intermediate member 42 is sized to allow insertion of the hub axle 2a. The dimension LA of the intermediate member 42 in the direction extending along the axis of the hub axle 2a is smaller than the dimension LB of the tube 11a excluding the portion where the flange 19b is arranged in the direction extending along the axis of the hub axle 2a. The intermediate member 42 is supported by the tube 11a of the attachment 19. The inner diameter of the intermediate member 42 is slightly larger than the outer diameter of the first portion 11e of the tube 11a. In the attachment unit 38, the intermediate member 42 is fitted to the tube 11a. Thus, the axial dimension of the first portion 11e is slightly larger than that of the first embodiment. The thread 11f does not have to be formed on the portion of the tube 11a supporting the intermediate member 42. In a view taken in a direction AX parallel to the axis of the hub axle 2a, the intermediate member 42 is arranged in a region located within the outer circumferential end of the flange 19b of the attachment 19.

The attachment 19 is coupled to the hub shell 2b. The flange 19b of the attachment 19 pushes the disc brake rotor 6 with the intermediate member 42 toward the shell body 2d. The outer diameter of the intermediate member 42 is larger than the outer diameter of the rotor support 2g of the hub shell 2b. Preferably, the outer circumference portion of the intermediate member 42 in the radial direction is ring-shaped. However, the shape is not limited. In a case in which the disc brake rotor 6 is used without coupling the disc brake rotor 6 to the hub shell 2b, the outer diameter of the intermediate member 42 can be less than or equal to the rotor support 2g of the hub shell 2b.

The magnetism generator 43 has the same structure as the magnetism generator 20 of the third embodiment or the magnetism generator 16 of the fourth embodiment. In a case in which the magnetism generator 43 has the same structure as the magnetism generator 20 of the third embodiment, the intermediate member 42 has the same structure as the magnetism generator 20. In a case in which the magnetism generator 43 has the same structure as the magnetism generator 16 of the fourth embodiment, the intermediate member 42 has the same structure as the receptacle 22b. In the attachment units 10, 14, 18, 22 and 26 of the first to fifth embodiments, the intermediate member 42 can be supported by the tube 11a of each of the attachments 11, 15, 19, 23 and 27 in the first to fifth embodiments.

### Seventh Embodiment

A seventh embodiment of an attachment unit 44 will now be described with reference to FIG. 20. The attachment unit 44 differs from the attachment unit 38 of the sixth embodiment only in the structure of an attachment 45. In the description hereafter, same reference numerals are given to those components that are the same as the corresponding components of the sixth embodiment. Such components will not be described in detail.

The attachment unit 44 includes the attachment 45 and the intermediate member 42, which is a member separate from the attachment 45. In addition to the structure of the attachment 19 in the sixth embodiment, the attachment 45 includes a second through hole 45b. The flange 19b of the attachment 45 includes one or more second through holes 45b. The second through hole 45b is formed in the attachment 45 to expose an opposing portion of an outer surface 42a of the intermediate member 42. The second through hole 45b extends through the flange 19b in the axial direction CD of the tube 11a. In a state in which the attachment 45 is coupled to the hub assembly 2, the attachment 45 and the intermediate member 42 are positioned relative to each other so that the second through hole 45b and the magnetism generator 43 of the intermediate member 42 are aligned in the circumferential direction around the rotational axis CA of the hub assembly 2. In the attachment units 10, 14, 18, 22, 26, 38 and 44 of the first to seventh embodiments, the attachment is simply fastened to the hub assembly 2 to fix the magnetism generator at a predetermined position of the hub shell 2b. This facilitates adjustment of the position of the magnetism generator compared to a case in which a magnet is attached to an elongated member such as a spoke.

### Eighth Embodiment

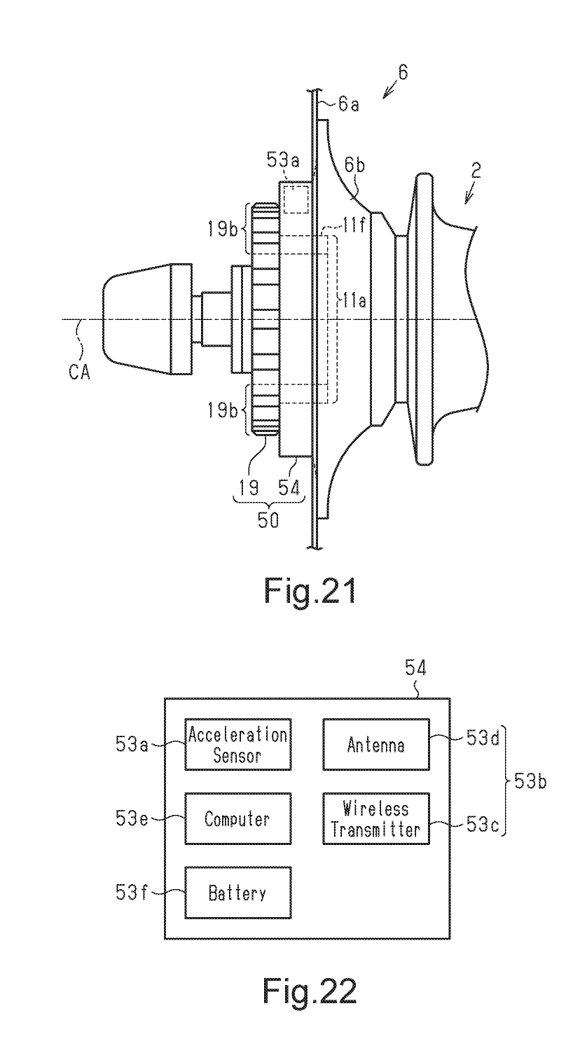

An eighth embodiment of an attachment unit 50 will now be described with reference to FIGS. 21 and 22. The attachment unit 50 includes an acceleration sensor 53a instead of a magnetism generator to detect the rotational state of the wheel 9. The attachment unit 50 and the attachment unit 38 of the sixth embodiment use the same attachment 19. In the description hereafter, same reference numerals are given to those components that are the same as the corresponding components of the sixth embodiment. Such components will not be described in detail.

The attachment unit 50 includes the attachment 19, the acceleration sensor 53a supported by the attachment 19, and a transmitter 53b.

The acceleration sensor 53a is accommodated in a casing 54. For example, the casing 54 is held between the flange 19b of the attachment 19 and the disc brake rotor 6 of the hub assembly 2. The casing 54 held between the flange 19b and the disc brake rotor 6 restricts rotation of the hub shell 2b around the rotational axis CA. The casing 54 is a hollow ring member. Thus, the casing 54 is hollow. In a view taken from a direction parallel to the axis of the hub axle 2a, the casing 54 can be arranged in a region located within the outer circumferential end of the attachment 19. At least a portion of the casing 54 is formed from a material that allows the transmission of radio waves. Preferably, the casing 54 is formed from a synthetic resin. The inner circumference of the casing 54 includes a thread that can be fastened with the thread 11f on the tube 11a of the attachment 19 to fasten the casing 54 with the attachment 19. At least a portion of the casing 54 and at least a portion of the attachment 19 can be formed from the same material to have a one-piece structure.

The attachment unit 50 further includes a computer 53e and a battery 53f. The casing 54 accommodates the acceleration sensor 53a, the computer 53e, the transmitter 53b, and the battery 53f. The transmitter 53b outputs information obtained from the acceleration sensor 53a to the outside. The transmitter 53b includes a wireless transmitter 53c and an antenna 53d. The acceleration sensor 53a detects changes in the acceleration in the direction of one axis, the directions of two axes, or the directions of three axes. In a case in which the acceleration sensor 53a detects acceleration in the direction of one axis, the acceleration sensor 53a detects acceleration in a tangential direction of a circle of which the center is the rotational axis CA of the hub assembly 2. In a case in which the acceleration sensor 53a detects acceleration in the directions of two axes, the acceleration sensor 53a detects acceleration in a tangential direction of a circle of which the center is the rotational axis CA of the hub assembly 2 and acceleration in a direction parallel to the rotational axis CA of the hub assembly 2. In a case in which the acceleration sensor 53a detects acceleration in the directions of three axes, the acceleration sensor 53a detects acceleration in a tangential direction of a circle of which the center is the rotational axis CA of the hub assembly 2, acceleration in a direction parallel to the rotational axis CA of the hub assembly 2, and acceleration in a radial direction of the circle of which the center is the rotational axis CA.

The rotational speed of the wheel 9 can be obtained from the acceleration in the tangential direction of a circle of which the center is the rotational axis CA of the hub assembly 2. The tilt angle of the wheel 9 with respect to the lateral direction of the bicycle can be obtained from the acceleration in the direction parallel to the rotational axis CA of the hub assembly 2.

The computer 53e controls the acceleration sensor 53a and the transmitter 53b. The computer 53e, which includes one or more microcomputers and a memory, executes predetermined programs stored in the memory. In other words, the computer 53e includes at least one processor and at least one computer memory device. Based on signals output from the acceleration sensor 53a, the computer 53e generates at least one of speed information indicating the rotational speed of the wheel 9 and tilt information indicating the tilt angle of the wheel 9. The wireless transmitter 53c converts at least one of the speed information and the tilt information generated by the computer 53c into a wireless signal. The antenna 53d transmits a wireless signal. The battery 53f supplies power to the transmitter 53b, the computer 53e, and the acceleration sensor 53a. Instead of the information generated by the computer 53e, the wireless transmitter 53c can convert the signals output from the acceleration sensor 53a into wireless signals. Instead of the battery 53f, the attachment unit 50 can include a battery holder that can hold the battery 53f. The attachment unit 50 can be attached to the hub assembly 2 that is free from the disc brake rotor 6. In this case, the casing 54 is held between the flange 19b and a portion of the hub shell 2b and fixed in a removable manner to the hub shell 2b.

### Ninth Embodiment

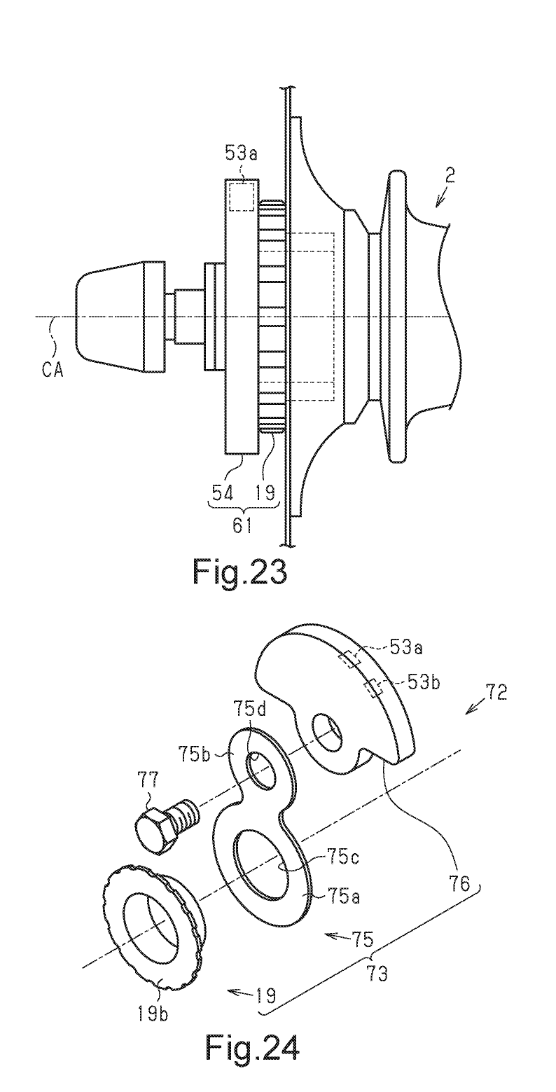

A ninth embodiment of the attachment unit 61 will now be described with reference to FIG. 23. The attachment unit 61 differs from the attachment unit 50 of the eighth embodiment only in the location of the casing 54 that includes the acceleration sensor 53a. In the description hereafter, same reference numerals are given to those components that are the same as the corresponding components of the eighth embodiment. Such components will not be described in detail. In the attachment unit 61, in a state in which the attachment unit 61 is coupled to the hub assembly 2, the acceleration sensor 53a is located at the outer side of the attachment 19 in the direction extending along the rotational axis CA of the hub assembly 2.

The casing 54 is, for example, adhered, welded, or brazed to the flange 19b of the attachment 19 to fix the casing 54 to the flange 19b. At least a portion of the casing 54 and at least a portion of the flange 19b can be formed from the same material to have a one-piece structure.

### Tenth Embodiment

A tenth embodiment of an attachment unit 72 will now be described with reference to FIG. 24. The attachment unit 72 differs from the attachment unit 61 of the ninth embodiment only in the structure for coupling the acceleration sensor 53a. In the description hereafter, same reference numerals are given to those components that are the same as the corresponding components of the ninth embodiment. Such components will not be described in detail. In the attachment unit 72, the acceleration sensor 53a is coupled to the hub assembly by a first member 75.

The attachment unit 72 includes an attachment 73 (entirely), the acceleration sensor 53a and the transmitter 53b. The acceleration sensor 53a and the transmitter 53b are supported by the attachment 73. The attachment 73 includes the attachment 19 of the ninth embodiment, the first member 75 and a second member 76. The first member 75 includes a base 75a and a support 75b. In a state in which the attachment 19 is attached to the hub assembly 2, the base 75a is held between the flange 19b of the attachment 19 and the rotor 6 or the end of the hub shell 2b. The support 75b movably supports the second member 76.

The first member 75 is plate-shaped. The base 75a includes a first through hole 75c through which the end of the hub assembly 2 is inserted. The support 75b includes a second through hole 75d through which a bolt 77 is inserted to fix the second member 76. The second member 76 is supported by the bolt 77 so that the second member 76 is rotatable relative to the support 75b around the axis of the bolt 77. The second member 76 includes a casing. In the same manner as the eighth embodiment, the casing is hollow and accommodates the acceleration sensor 53a, the computer 53e, the transmitter 53b, and the battery 53f. The second member 76 includes a threaded hole that is engageable with the bolt 77.

At least a portion of the second member 76 can be arranged in a hole formed in the rotor 6 or extend through a hole formed in the rotor 6. This reduces outward projection of the second member 76 in the axial direction of the hub axle 2a. The bolt 77 can be integrally formed with the first member 75, and the threaded hole of the second member 76 can be a through hole. In this case, a nut is used to fix the bolt 77. The bolt 77 is fixed to the second member 76 so that the second member 76 is held between the nut and the first member 75. As long as the first member 75 and the second member 76 are coupled in a movable manner relative to each other, the first member 75 and the second member 76 can be coupled in a different manner.

### Eleventh Embodiment

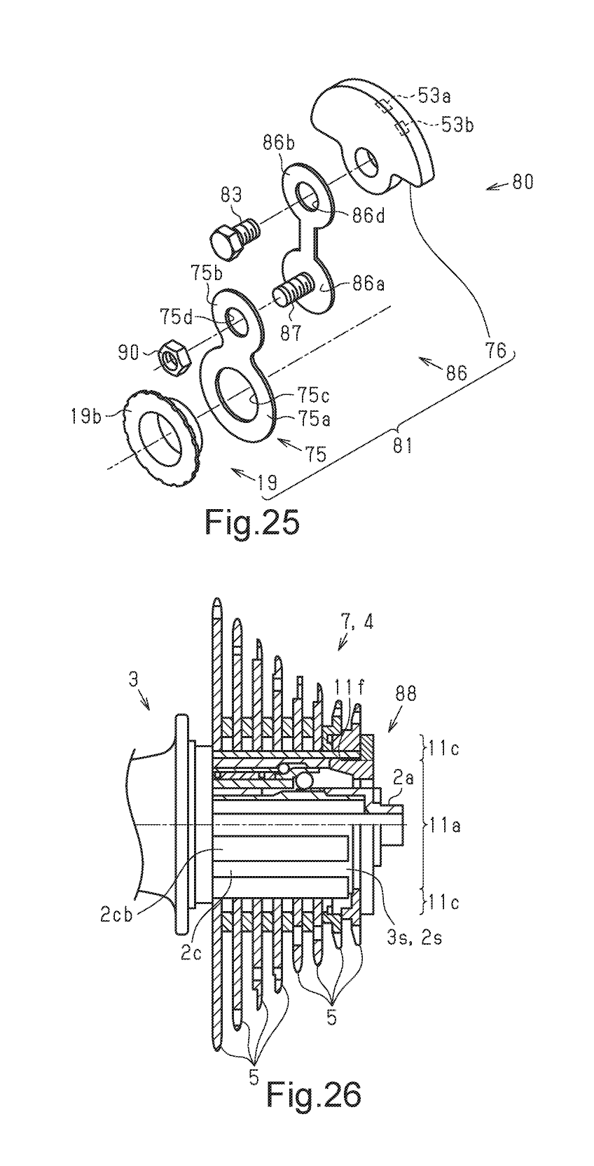

An eleventh embodiment of an attachment unit 80 will now be described with reference to FIG. 25. The attachment unit 80 differs from the attachment unit 72 of the tenth embodiment only in the structure of the attachment 73. In the description hereafter, same reference numerals are given to those components that are the same as the corresponding components of the tenth embodiment. Such components will not be described in detail. In addition to the structure of the attachment unit 72, the attachment unit 80 further includes a third member 86.

An attachment 81 of the attachment unit 80 includes the attachment 19, the first member 75, the second member 76, and the third member 86. The attachment unit 80 is a structure that couples the first member 75 and the second member 76 with the third member 86 in the attachment unit 72 of the tenth embodiment. The third member 86 is movably coupled to the first member 75.

The third member 86 is plate-shaped. The third member 86 includes a first support 86a that supports a bolt 87 and a second support 86b that supports the second member 76. The bolt 87 is integrally formed with the first support 86a. The bolt 87 is inserted through the second through hole 75d of the first member 75, and the first member 75 is held between a nut 90 and the first support 86a so that the third member 86 is movably supported relative to the first member 75 around the axis of the bolt 87. The second support 86b includes a through hole 86d through which a bolt 83 is inserted and fixed to the second member 76. The second member 76 is movably supported by the bolt 83 relative to the second support 86b around the axis of the bolt 83.

The bolt 87 and the third member 86 can be separate bodies. For example, a through hole can be formed in the first support 86a of the third member 86, and a bolt can be inserted through the through hole and coupled to the first member 75. As long as the first member 75 and the third member 86 are coupled in a movable manner relative to each other, the first member 75 and the third member 86 can be coupled in a different manner. The third member 86 increases the degree of freedom for positioning the second member 76 to arrange at least a portion of the second member 76 in a hole formed in the rotor 6 or insert at least a portion of the second member 76 through a hole formed in the rotor 6.

### Twelfth Embodiment

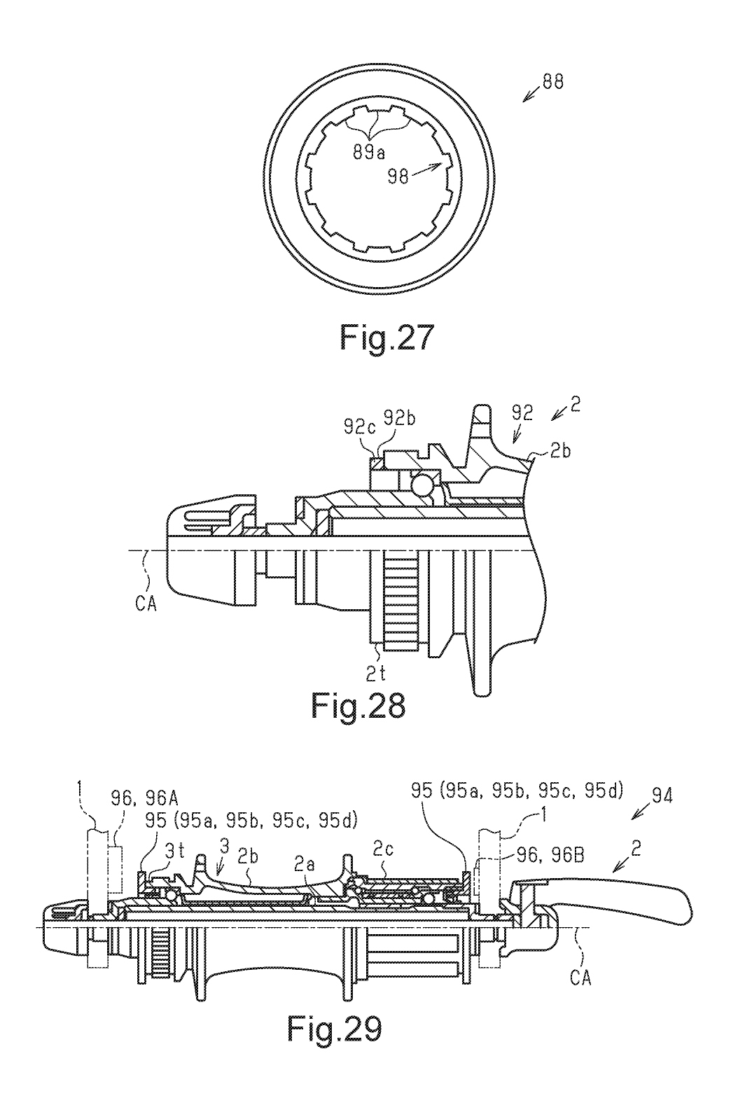

A twelfth embodiment of an attachment unit 88 will now be described with reference to FIGS. 26 and 27. In the direction extending along the rotational axis CA of the hub assembly 2, the attachment unit 88 is attached to an end 3s of the portion 3 of the hub assembly 2 that is rotatable relative to the hub axle 2a to push the rear sprocket assembly 7 in the direction extending along the axis of the hub axle 2a and fix the rear sprocket assembly 7 to the freewheel 2c. The attachment unit 88 is attached to the end 2s of the freewheel 2c. The rear sprocket assembly 7 includes at least one rear sprocket 5. The rear sprockets 5 can be gears driven by a chain or pulleys driven by a belt.

In addition to the structure of any one of the attachment units 10, 14, 18, 22, 38, 44, 50, 61, 72 and 80, the attachment unit 88 includes a third engagement portion 98 that is engageable with a tool and formed in the inner circumference of the tube 11a. FIG. 26 shows a case in which the attachment unit 88 includes the structure of the attachment unit 10. The thread 11f formed on the outer circumference of the tube 11a is engageable with a thread formed on the inner circumference of the sprocket supporting portion 2cb of the freewheel 2c. The outer diameter of the flange 11c of the attachment unit 88 is larger than the inner diameter of the rear sprocket assembly 7. In a case in which the attachment unit 88 includes the third engagement portion 98, the first engagement portion 11d can be omitted.

The third engagement portion 98 includes projections 89a that engage a tool used to rotate the attachment unit 88 around the axis of the hub axle 2a. The projections 89a are arranged at equal intervals in the circumferential direction around the axis of the hub axle 2a. The projections 89a project in the radial direction with respect to the rotational axis CA of the hub axle 2a. The projections 89a can be detected by a sensor (refer to fourteenth embodiment). In a case in which the inner circumference of the sprocket supporting portion 2cb does not include a thread and the rear sprocket assembly 7 is fixed to the freewheel 2c of which the sprocket supporting portion 2cb has a thread formed on the outer circumference, the attachment unit 88 is formed by the attachment unit 26. The thread 27c formed on the inner circumference of the tube 11a (thread structure of fifth embodiment) is engageable with the thread formed on the outer circumference of the sprocket supporting portion 2cb. In a case in which the attachment unit 88 having the structure of any one of the attachment units 50, 61, 72 and 80 is attached to the end of the freewheel 2c, the computer 53e generates speed information indicating the rotational speed of the rear sprocket assembly 7 instead of speed information indicating the rotational speed of the wheel 9.

### Thirteenth Embodiment

A bicycle hub assembly 92 will now be described with reference to FIG. 28. In addition to the structure of the bicycle hub assembly 2 shown in FIG. 1, the bicycle hub assembly 92 includes a magnetism generator 92b. In the description hereafter, same reference numerals are given to those components that are the same as the corresponding components of the bicycle hub assembly 2. Such components will not be described in detail. The bicycle hub assembly 92 includes the hub shell 2b and the magnetism generator 92b. The magnetism generator 92b is arranged in a non-removable manner on the end 2t of the hub shell 2b in the direction extending along the rotational axis CA of the hub shell 2b.

The magnetism generator 92b can be magnetized, for example, at the end 2t of the hub shell 2b. FIG. 28 shows a case in which the end 2t of the hub shell 2b is magnetized to form a magnetized portion 92c. The magnetization is performed in the same manner as the attachment magnetized in the first embodiment. The magnetism generator 92b can be formed by a magnet like the magnetism generator 16 of the second embodiment, and the magnet can be received in a receptacle that is integrally formed with the hub shell 2b. The magnetism generator 92b can be formed like the magnetism generator 20 of the third embodiment and be fixed to the outer surface of the hub shell 2b. Alternatively, the magnetism generator 92b can be formed like the magnetism generator 16 of the fourth embodiment, and the receptacle 22b can be fixed to the outer surface of the hub shell 2b. In a case in which the magnetism generator 92b is formed without undergoing magnetization, a magnet and a receptacle are brazed, welded, or adhered to the hub shell 2b. In a state in which the attachment unit of the first to eighth embodiments are attached to the hub shell 2b, the attachment units 10, 14, 18, 22, 26, 38, 44 and 50 can each be swaged with the hub shell 2b so that the attachment unit is fixed in a non-removable manner to the hub shell 2b.

### Fourteenth Embodiment

A bicycle hub assembly detection system 94 will now be described with reference to FIG. 29. In the bicycle hub assembly detection system 94, same reference numerals are given to those components that are the same as the corresponding components of the above embodiments. Such components will not be described in detail. The bicycle hub assembly detection system 94 includes a detected portion 95 and a sensor 96. The detected portion 95 is located on the end 3t of the portion 3 of the hub assembly 2 that is rotatable relative to the hub axle 2a in the direction extending along the rotational axis CA of the hub assembly 2, which includes the hub axle 2a. The sensor 96 is arranged on the bicycle frame 1 and detects the detected portion 95 to output a signal corresponding to the rotational state of the hub assembly 2.

The detected portion 95 includes one of the attachment units 10, 14, 18, 22, 26, 38, and 44 of the above embodiments. The detected portion 95 is coupled to one or both ends of the portion 3 of the hub assembly 2 that is rotatable relative to the hub axle 2a. The sensor 96 is coupled to the surface of the bicycle frame 1 at the wheel side. One end of the portion 3 of the hub assembly 2 that is rotatable relative to the hub axle 2a is included in the hub shell 2b. The other end of the portion 3 of the hub assembly 2 that is rotatable relative to the hub axle 2a is included in the freewheel 2c. A sensor that detects the detected portion 95 attached to the hub shell 2b is referred to as a first sensor 96A, and a sensor detects the detected portion 95 attached to the side of the freewheel 2c is referred to as a second sensor 96B. The detected portion 95 includes one of a magnetism generator 95a, a permeability changing portion 95b, an electromagnetic wave changing portion 95c and a stepped portion 95d.

The magnetism generator 95a is a portion that generates magnetism. In a case in which the detected portion 95 includes the magnetism generator 95a, for example, each of the attachment units 10, 14, 18, 22, 26, 38 and 44 can be used as the detected portion 95. In a case in which the detected portion 95 includes the magnetism generator 95a, the sensor 96 is configured as a sensor that detects magnetism and includes a reed switch, a Hall element, or a magnetoresistance effect element (MR sensor).

In a case in which the detected portion 95 includes the permeability changing portion 95b, the electromagnetic wave changing portion 95c, or the stepped portion 95d, for example, the magnetism generator of each of the attachment units 10, 14, 18, 22, 26, 38 and 44 can be replaced by the permeability changing portion 95b, the electromagnetic wave changing portion 95c, or the stepped portion 95d.

The permeability changing portion 95b is where the permeability changes around the rotational axis CA of the hub assembly 2. The permeability changing portion 95b can be arranged around the rotational axis CA of the hub assembly 2 to change the permeability at only one location or change the permeability at a number of locations spaced apart at equal intervals. For example, the permeability changing portion 95b is formed by an iron or a material other than iron. Examples of a material other than iron include aluminum alloys and resin. If the permeability changing portion 95b is employed, the sensor 96 is formed by a magnetic induction proximity sensor. The magnetic induction proximity sensor includes a coil that generates high-frequency magnetism. The magnetism induction proximity sensor detects inductance changes in its coil resulting from changes in the magnetoresistance around the coil. The magnetic inductance proximity sensor detects changes in the permeability at the permeability changing portion 95b.

The electromagnetic wave changing portion 95c is where the reflectance of electromagnetic waves is different around the rotational axis CA of the hub assembly 2. The electromagnetic wave changing portion 95c can be arranged around the rotational axis CA of the hub assembly 2 to change the reflectance of electromagnetic waves at only one location or change the permeability at a number of locations spaced apart at equal intervals. Electromagnetic waves include, for example, radio waves and light. The electromagnetic wave changing portion 95c can be formed by one or more electromagnetic wave diffusion grooves, one or more radio wave absorbing bodies, and one or more colored portions having a predetermined color. The electromagnetic wave diffusion grooves, the radio wave absorbing bodies, and the colored portions are defined by parts of the hub assembly 2 arranged around the rotational axis CA. If the electromagnetic wave changing portion 95c is employed, the sensor 96 is formed by a reflection sensor. The reflection sensor includes a light projector or transmitter that projects electromagnetic waves and a light receiver or receiver that detects the radio waves reflected by the electromagnetic wave changing portion 95c.

The stepped portion 95d of the hub assembly 2 includes steps arranged around the rotational axis CA. Examples of the stepped portion 95d include the first engagement portion 11d of the attachment 11 in the first embodiment, the grooves of the rotor support 2g, and the projections 89a of the attachment unit 88 in the twelfth embodiment. The stepped portion 95d can include a recess and a projection in the radial direction of the hub axle 2a or a recess and a projection in the axial direction of the hub axle 2a. The step can be arranged on the hub assembly 2 at one or more locations around the rotational axis CA. If the stepped portion 95d is employed, the sensor 96 is formed by a reflection sensor. The rotational speed of the wheel 9, the acceleration of the wheel 9, and the like can be obtained based on the signal output from the first sensor 96A. Further, the rotational speed of the bicycle crank, the angular velocity of the bicycle crank, and the like can be obtained based on the signal output from the second sensor 96B. It can also be determined whether or not the crank is rotating based on the signal output from the second sensor 96B. Another sensor that detects the gear ratio can be employed to obtain the rotational speed of the bicycle crank, the angular velocity of the bicycle crank, and the like.

### Other Embodiments

It should be apparent to those skilled in the art that the present invention can be embodied in many other specific forms without departing from the spirit or scope of the invention. Particularly, it should be understood that the present invention can be embodied in the following forms.

The magnetism generator of the attachment unit can include, for example, both of the magnetized portion and the magnet. In the first embodiment, the attachment 11 is magnetized. Instead of or in addition to magnetizing the attachment 11, the hub coupling member 6b can be magnetized.

The acceleration sensor 53a can be fastened to a fastening portion of the rotor 6 and the hub coupling member 6b by a fastening bolt that fastens the rotor 6 and the hub coupling member 6b. In this case, the casing 54 shown in FIG. 23 can be coupled to the fastening bolt. Alternatively, the third member 86 shown in FIG. 25 can be coupled to the fastening bolt. The first engagement portion 11d can be omitted from each of the attachment units 10, 14, 18, 22, 38 and 44, and the third engagement portion 98 can be formed in the inner circumference of the tube 11a. Preferably, the third engagement portion 98 is formed in the inner circumference of the portion of the tube 11a where the flange is formed. The front hub assembly is similar to the rear hub assembly, except that the freewheel 2c is eliminated and is thus not described in detail. In a case in which the front hub assembly includes one of the attachment units 10, 14, 18, 22, 26, 38, 44, 50, 61, 72, 80 and 88, an inner thread or an outer thread is formed on the end of the hub shell at the side opposite to where the disc brake rotor is coupled in the direction extending along the rotational axis of the hub assembly to arrange the attachment unit 10, 14, 18, 22, 26, 38, 44, 50, 61, 72, 80 or 88. In a case in which the magnetism generator 92b is arranged on the front hub assembly, the magnetism generator 92b can be arranged on the end of the hub shell at the side opposite to where the disc brake rotor is coupled. In each of the above embodiments, the tube 11a has the form of a round tube. Instead, the first portion 11e can include one or more grooves extending parallel to the axis CB. In this case, the first portion 11e is formed by a number of segments arranged around the axis CB at certain intervals. The tube 11a itself can be formed by a number of segments arranged around the axis CB at certain intervals. In each of the above embodiments, the tubes 11a and 27a include the threads 11f and 27c but can have any form as long as they are engageable with the thread of the hub assembly. For example, a plate spring that is pushed and widened in the radial direction can be arranged on the outer circumference of each tube 11a and 27a so that the plate spring is engaged with a thread of the hub assembly.

What is claimed is:

1. A hub assembly attachment unit comprising:
an attachment that is attachable to a thread at an end of a portion of a bicycle hub assembly that is rotatable relative to a hub axle in a direction extending along a rotational axis of the bicycle hub assembly, the thread being arranged coaxially with the rotational axis of the bicycle hub assembly; and
a magnetism generator arranged integrally with the attachment.

2. The hub assembly attachment unit according to claim 1, wherein
the attachment includes a tube,
the tube includes an inner circumference and an outer circumference, and
one of the inner circumference and the outer circumference includes a thread.

3. The hub assembly attachment unit according to claim 1, wherein
the attachment further includes a stopper configured to restrict movement of a rotational member attached to the bicycle hub assembly in the direction extending along the rotational axis of the bicycle hub assembly in a state in which the attachment is attached to the bicycle hub assembly.

4. The hub assembly attachment unit according to claim 2, wherein
the attachment further includes a stopper configured to restrict movement of a rotational member attached to the bicycle hub assembly in the direction extending along the rotational axis of the bicycle hub assembly in a state in which the attachment is attached to the bicycle hub assembly, and
the stopper projects outward in a radial direction from the outer circumference of the tube.

5. A hub assembly attachment unit comprising:
an attachment that is attachable in a removable manner to a bicycle hub assembly including a hub axle, wherein the attachment is configured to restrict movement of a rotational member attached to the bicycle hub assembly in a direction in which the hub axle extends in a state in which the attachment is attached to the bicycle hub assembly; and
a magnetism generator arranged in a region located within an outer circumferential end of the attachment in a view taken from a direction parallel to the hub axle.

6. The hub assembly attachment unit according to claim 3, wherein
the rotational member includes one of a disc brake rotor and a rear sprocket.

7. The hub assembly attachment unit according to claim 1, wherein
the magnetism generator includes a magnetized portion obtained by magnetizing at least a portion of the attachment.

8. The hub assembly attachment unit according to claim 7, wherein
the magnetized portion is located at a number of positions around an axis of the hub axle.

9. The hub assembly attachment unit according to claim 1, wherein
the magnetism generator is fixed to an outer surface of the attachment.

10. The hub assembly attachment unit according to claim 1, wherein
the attachment further includes a receptacle that receives the magnetism generator.

11. The hub assembly attachment unit according to claim 10, wherein
the receptacle is formed from a material that differs from that of a portion of the attachment excluding the receptacle.

12. The hub assembly attachment unit according to claim 11, wherein
the receptacle is located at an outer side of a portion of the attachment excluding the receptacle in the direction in which the hub axle extends in a state in which the attachment is attached to the bicycle hub assembly.

13. The hub assembly attachment unit according to claim 10, wherein
the magnetism generator is press-fitted into, adhered to, or embedded in the receptacle.

14. The hub assembly attachment unit according to claim 5, wherein
the attachment further includes an intermediate member held between the attachment and the rotational member in the direction in which the hub axle extends in a state in which the attachment is attached to the bicycle hub assembly.

15. The hub assembly attachment unit according to claim 14, wherein
the intermediate member includes a first through hole through which a portion of the bicycle hub assembly extends.

16. The hub assembly attachment unit according to claim 14, wherein
the attachment includes a low permeability portion having a lower permeability than iron.

17. The hub assembly attachment unit according to claim 14, wherein
the attachment includes a second hole formed to expose an opposing portion of an outer surface of the intermediate member in a state in which the attachment is attached to the bicycle hub assembly.

18. The hub assembly attachment unit according to claim 1, wherein
the magnetism generator includes a magnet.

19. The hub assembly attachment unit according to claim 18, wherein
the magnet is arranged at a number of locations around an axis of the hub axle.

20. The hub assembly attachment unit according to claim 18, wherein
the magnet includes an annular multipolar magnet.

21. The hub assembly attachment unit according to claim 1, wherein
the attachment includes an engagement portion that is engageable with a tool.

22. A hub assembly attachment unit comprising:
an attachment that is attachable to an end of a portion of a bicycle hub assembly that is rotatable relative to a hub axle in a direction extending along a rotational axis of the bicycle hub assembly, which includes the hub axle;
an acceleration sensor supported by the attachment; and
a transmitter supported by the attachment, wherein the transmitter outputs information obtained from the acceleration sensor to outside the hub assembly attachment unit.

23. The hub assembly attachment unit according to claim 22, wherein
the attachment includes a through hole through which a portion of the bicycle hub assembly extends.

24. The hub assembly attachment unit according to claim 23, wherein
the attachment includes:
a first member that includes a through hole; and
a second member that is movable relative to the first member, wherein the acceleration sensor is coupled to the second member.

25. The hub assembly attachment unit according to claim 23, wherein
the attachment is attachable to a thread that is arranged coaxially with the rotation shaft at the end of bicycle hub assembly.

26. A bicycle hub assembly comprising:
a hub shell; and
a magnetism generator arranged in a non-removable manner on an end of the hub shell in a direction extending along a rotational axis of the hub shell.

27. A bicycle hub assembly state detection system comprising:
a detected portion arranged at an end of a portion of a bicycle hub assembly that is rotatable relative to a hub axle in a direction extending along a rotational axis of the bicycle hub assembly, which includes the hub axle;
a sensor arranged on a bicycle frame, wherein the sensor detects the detected portion and outputs a signal corresponding to a rotational state of the bicycle hub assembly;
the detected portion including at least one of a permeability changing portion, at which permeability changes around the rotational axis of the bicycle hub assembly, an electromagnetic wave changing portion, at which reflectance of an electromagnetic wave changes around the rotational axis of the bicycle hub assembly, and a stepped portion, which includes a step around the rotational axis of the bicycle hub assembly.
